(19) United States
(12) Patent Application Publication
(10) Pub. No.: US 2013/0003730 A1
(43) Pub. Date: Jan. 3, 2013

(54) PATH SEARCH PROGRAM, PATH SEARCH APPARATUS AND PATH SEARCH METHOD

(75) Inventors: Kazuyuki Tajima, Yokosuka (JP); Tomohiro Hashiguchi, Inagi (JP); Yutaka Takita, Kawasaki (JP)

(73) Assignee: FUJITSU LIMITED, Kawasaki-shi (JP)

(21) Appl. No.: 13/469,237

(22) Filed: May 11, 2012

(30) Foreign Application Priority Data
Jun. 30, 2011 (JP) 2011-146346

(51) Int. Cl. H04L 12/56

(52) U.S. Cl. 370/389

(57) ABSTRACT

A computer-readable recording medium having stored therein a program for causing a computer to execute a process includes accepting a start node and finish node that are both terminuses for a circuit that is to be accommodated in a transmission network that includes a plurality of transmission lines, selecting, from the plurality of transmission lines, a transmission line whose arrangement order of arranging a plurality of nodes on the transmission line in an order of an indicated direction determined for the transmission line is the same as an order of the plurality of nodes determined in accordance with a cost order of the shortest path from a node at a terminus of the circuit to the plurality of nodes, and searching for a path from the circuit's start node to the circuit's finish node via the selected transmission line in the order of the indicated direction.

### CROSS-REFERENCE TO RELATED APPLICATIONS

This application is based upon and claims the benefit of priority of the prior Japanese Patent Application No. 2011-146346, filed on Jun. 30, 2011, the entire contents of which are incorporated herein by reference.

### FIELD

The embodiments discussed herein are related to a path search to accommodate a circuit in a transmission network.

### BACKGROUND

When accommodating a circuit in a transmission network formed by multiplexed transmission lines, selection of a multiplexed transmission line to accommodate the circuit, in other words a demand, is referred to as a circuit capacity design. As a related-art method of circuit capacity design, there is a method of generating a logical topology that uses a multiplexed transmission line, which has free bandwidth, as a link, and finding a path that accommodates the demand in the logical topology.

In this regard, a communication system that includes a plurality of communication node devices and establishes communication paths by exchanging messages among the plurality of communication node devices is known. In the system, before establishing paths, a path's identifier, which permits or inhibits use of the path's resources, is determined, and the paths are established with a control message that includes determined identification information. In a communication node unit whose paths have been established, a determination of whether or not to use resources of a path is made based on the identification information in the control message. When an event occurs, such as occurrence of a breakdown, occurrence or cessation of resources being used, and so on, it may be possible to perform change processing on path priority so as to change the priority in order to use resources most efficiently.

In addition, a method of processing for network topology/link-capacity design is known. In this method, data including at least a node position, a traffic exchange matrix, a routing method, and a value γ, which specifies an arbitrary upper limit of a link's use rate at normal times, are used as restriction conditions. An input processing unit receives input of a number of links L disposed among all the nodes, and a given number of links k (<L) in addition to the restriction conditions. When a design processing unit keeps a use rate of each link at normal times to the specified value γ or less and calculates a network topology and a link capacity that attempts to minimize the total network cost, the restriction conditions are that the design processing unit limits links to k upper-ranked links having a high traffic volume, and maintains connectivity among all the nodes even if a single failure occurs in each of the remaining L-k links. Under these restriction conditions, the design processing unit calculates a net topology and a link capacity with consideration given to rerouting traffic when there is a single link failure of each link.

An optical communication network that divides a working path into partial paths and manages the partial paths is known. The optical communication network includes a function of detecting a failure of each of the partial paths, a function of notifying a failure detection result for each of the partial paths to a node that performs switching management, and a function of switching based on a detour path determined by the switching management node for each partial path in advance, wherein a monitoring end node of a partial path, which performs monitoring, and a switching end node of a recovery path are different.

A network in which an upper node that has received a link state advertisement (LSA) packet holds off on update of the own topology information for a given time period is known. The upper node does not immediately update the node's own topology information when a network failure occurs, but holds off on update for a certain period of time in expectation of quick recovery of a lower network, and thereby route calculation that would be invalid may be avoided.

Related-art techniques have been disclosed in International Publication Pamphlet No. WO 2008/044646, Japanese Laid-open Patent Publication No. 2009-118201, Japanese Laid-open Patent Publication No. 2003-258851, and Japanese Laid-open Patent Publication No. 2003-258904.

### SUMMARY

According to an aspect of the invention, a computer-readable recording medium having stored therein a program for causing a computer to execute a process includes accepting a start node and finish node that are both terminuses for a circuit that is to be accommodated in a transmission network that includes a plurality of transmission lines, selecting, from the plurality of transmission lines, a transmission line whose arrangement order of arranging a plurality of nodes on the transmission line in an order of an indicated direction determined for the transmission line is the same as an order of the plurality of nodes determined in accordance with a cost order of the shortest path from a node at a terminus of the circuit to the plurality of nodes, and searching for a path from the circuit's start node to the circuit's finish node via the selected transmission line in the order of the indicated direction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a state in which the same circuit is redundantly accommodated in a plurality of transmission lines in the same section.

FIG. 2 is a diagram illustrating an example of a hardware configuration of a path search apparatus.

FIG. 3 is a diagram illustrating an example of a configuration for a transmission network and a network control device.

FIG. 4 is a diagram illustrating an example of a configuration of the path search apparatus.

FIG. 5 is a diagram illustrating an example of physical connection information.

FIG. 6 is an explanatory diagram of a physical topology of a transmission network corresponding to the physical connection information in FIG. 5.

FIG. 7 is a diagram illustrating an example of shortest distance information.

FIG. 8 is a diagram illustrating an example of transmission line information.

FIG. 9 is a diagram illustrating a first example of route information.

FIG. 10 is an explanatory diagram of an example of setting transmission lines.

FIG. 11 is a diagram illustrating a second example of route information.

FIG. 12 is a diagram illustrating an example of a first configuration of a transmission-line selection unit.

FIG. 13 is an explanatory diagram of link direction information.

FIG. 14A and FIG. 14B are explanatory diagrams of a comparison result between link directions and transmission line directions.

FIG. 15 is an explanatory diagram of transmission lines selected by the transmission-line selection unit.

FIG. 16 is an explanatory diagram of a logical topology formed by the selected transmission lines.

FIG. 17 is an explanatory diagram of paths on a logical topology obtained by path search.

FIG. 18 is an explanatory diagram of paths on a physical topology obtained by path search.

FIG. 19 is an explanatory diagram of a first example of path search processing.

FIG. 20 is an explanatory diagram illustrating a first example of determination processing of a shortest distance.

FIG. 21 is an explanatory diagram of a first example of a method of determining a link direction.

FIG. 22 is an explanatory diagram of determination processing of a selection target of a transmission line.

FIG. 23 is an explanatory diagram illustrating a second example of a method of determining a shortest distance.

FIG. 24 is an explanatory diagram of a second example of a method of determining a link direction.

FIG. 25A and FIG. 25B are explanatory diagrams of processing examples when shortest distances of both end nodes of a link are same.

FIG. 26 is a diagram illustrating an example of a second configuration of the transmission-line selection unit.

FIG. 27 is an explanatory diagram of an example of a shortest distance list.

FIG. 28 is an explanatory diagram of a second example of the path search processing.

FIG. 29 is a diagram illustrating an example of a third configuration of the transmission-line selection unit.

FIG. 30 is an explanatory diagram of an example of a node list.

FIG. 31 is an explanatory diagram of a third example of the path search processing.

FIG. 32 is an explanatory diagram of a shortest distance table.

FIG. 33 is a diagram illustrating a second example of a configuration of the path search apparatus.

FIG. 34 is an explanatory diagram of determination processing of whether to search a path or not.

### DESCRIPTION OF EMBODIMENTS

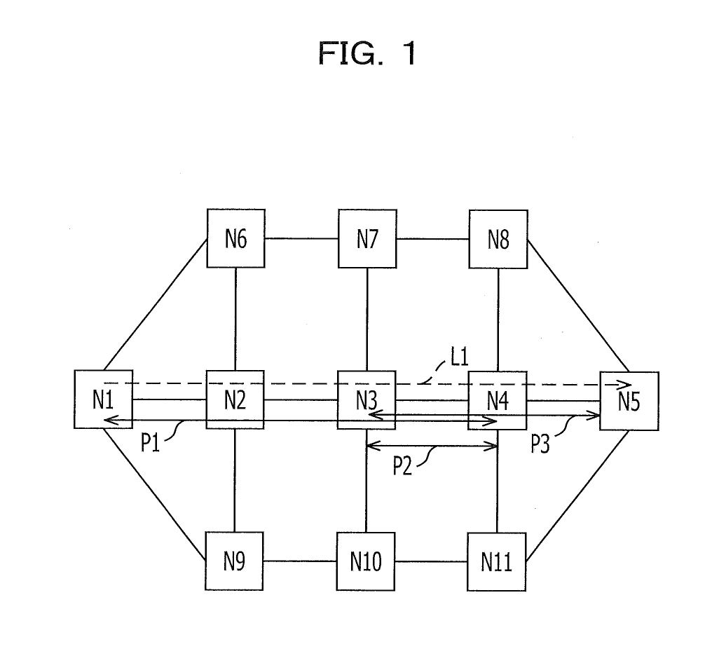

When using a method of a related-art circuit capacity design, the same circuit is sometimes redundantly accommodated in a plurality of transmission lines in the same section. FIG. 1 illustrates an example of a state in which the same circuit is redundantly accommodated in a plurality of transmission lines in the same section. In FIG. 1, reference numerals N1 to N11 denote exchange stations that are nodes in a transmission network. Solid lines that have no arrow and couple the individual nodes N1 to N11 denote physical connections that are links coupling the nodes at both ends.

A circuit L1 having the nodes N1 and N5 as a start point and an end point, respectively, is accommodated in individual multiplexed transmission lines P1, P2 and P3. The transmission line P1 is a multiplexed transmission line established among the nodes N1 to N4, the transmission line P2 is a multiplexed transmission line established among the nodes N3 to N4, and the transmission line P is a multiplexed transmission line established among the nodes N3 to N5.

As illustrated in FIG. 1, the plurality of paths that accommodate the circuit L1 overlap in the section between the nodes N3 and N4, and thus a resource three times the bandwidth resource demanded for signal transmission in this section is consumed. If the transmission medium is cut between the nodes N3 and N4, the cut may look like multiple failures occurred in that the transmission lines P1, P2 and P3 have been cut at the same time, which is complicated from a network management standpoint.

An object of the disclosed apparatus and method is to avoid redundantly accommodating the same circuit in a plurality of transmission lines in the same section.

### 1. First Embodiment

### 1.1 Configuration

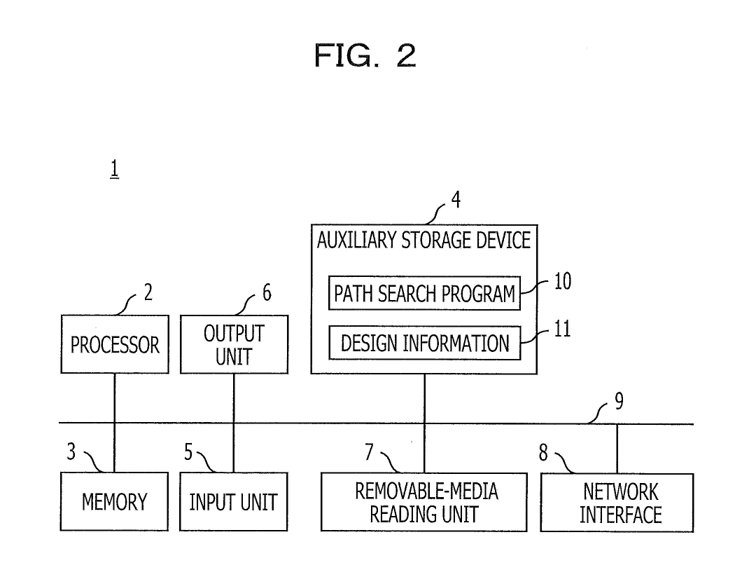

In the following, a description is given of preferable embodiments with reference to the accompanying drawings. FIG. 2 is a diagram illustrating an example of a hardware configuration of a path search apparatus. The path search apparatus 1 is a computer apparatus, and includes a processor 2, a memory 3, an auxiliary storage unit 4, an input unit 5, an output unit 6, a removable-media reading unit 7, and a network interface 8. These components 2 to 8 are mutually coupled through a bus 9. The auxiliary storage unit 4 stores a path search program 10, and design information 11 to be used for circuit capacity design by the path search program.

The path search apparatus 1 may be achieved by a single computer unit, or may be achieved by a computer system in which a plurality of computer units collaborate through a network. The hardware configuration illustrated in FIG. 2 is merely one hardware configuration that realizes the path search apparatus 1. Any other hardware configuration may be employed if processing described in the following is able to be performed.

The processor 2 runs the path search program 10 stored in the auxiliary storage unit 4 so as to perform circuit-capacity-design processing to accommodate a demand, in other words a circuit that is to be accommodated, in a transmission network. In this regard, a transmission network that is to be a target of circuit capacity design in the present embodiment may be a transmission network formed by a plurality of time division multiplexing (TDM) transmission lines. In a certain embodiment, a network, which transmits by replacing a TDM transmission line with a wavelength division multiplexing (WDM) technique, may be a target of the circuit capacity design. In fiber-optic communications, WDM is a technology which multiplexes a number of optical carrier signals onto a single optical fiber by using different wavelengths of laser light. In addition, the auxiliary storage unit 4 may include a nonvolatile memory, a read only memory (ROM), a hard disk, and so on, as a storage element.

The memory 3 stores a program being executed by the processor 2 and data that is temporarily used by the program. The memory 3 may include a random access memory (RAM). The input unit 5 is an input unit that accepts an input operation by a user. The input unit 5 may be, for example, a keypad, a keyboard, a pointing device, a touch panel, or so on.

The output unit 6 is an output device that outputs a result of circuit capacity design by the path search apparatus 1. For example, the output unit 6 may be a display device that visibly displays the result of the circuit capacity design. The output unit 6 may be, for example, a liquid crystal display, a cathode ray tube (CRT) display, or an organic electroluminescence display.

The removable-media reading unit 7 is an input unit that reads data stored in a computer-readable portable recording medium. The removable-media reading unit 7 may be, for example, a CD-ROM drive, a DVD-ROM drive, a floppy-disk drive, a CD-R drive, a DVD-R drive, a magneto-optical (MO) disc drive unit, or an access unit for flash memory.

The network interface 8 exchanges various kinds of data with a network, such as a local area network (LAN), the Internet, and so on, and may receive programs to be installed in the auxiliary storage unit 4. The network interface 8 may output a result of circuit capacity design through a network.

In the present embodiment, the path search program 10 may be stored in a computer readable portable recording medium and distributed, and then may be installed in the auxiliary storage unit 4 from the removable-media reading unit 7. In another embodiment, path search program 10 may be installed in the auxiliary storage unit 4 through the network and the network interface 8. In the path search apparatus 1, hardware, such as the processor 2, the memory 3, the auxiliary storage unit 4, and so on, and an OS and path search program 10 cooperate organically so as to achieve various functions described below.

In a certain embodiment, the path search apparatus 1 may be achieved as a network design apparatus that carries out circuit capacity design of a demand, which is scheduled to be accommodated in a transmission network, when the transmission network isn't operating. In another embodiment, the path search apparatus 1 may be achieved as a network control device that establishes a path for a demand by controlling setting of a network unit on the transmission network if the demand occurs while the transmission network is operating.

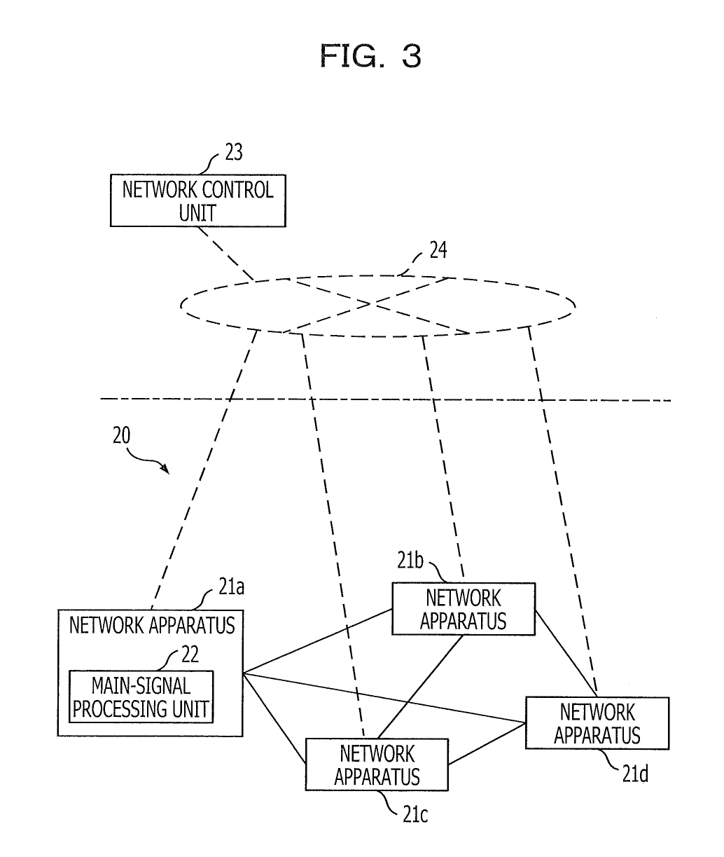

FIG. 3 is a diagram illustrating an example of a configuration of a transmission network and a network control device. A transmission network 20 includes network units 21a to 21d, which are disposed at corresponding exchange stations, and physical connections that couple the network units 21a to 21d and transmit main signals. The network units 21a to 21d are generically expressed as a “network unit 21”. The network unit 21 includes a main-signal processing unit 22 for setting a path to transmit a main signal. The main-signal processing unit 22 has a circuit interface that inputs and outputs a main signal to the physical connections, the physical connections and time slots that transmit the main signal in accordance with the set paths, and a, for example, switch that changes wavelengths.

The network control device 23 transmits and receives control signals with each network unit 21 through, for example, a LAN 24. When a demand occurs, the network control device 23 accepts input of demand information that includes a demand bandwidth, which is to be accommodated in the transmission network 20, and a start node and an end node of the demand. The network control device 23 searches for a path to accommodate the demand, and changes the setting of the main-signal processing unit 22 of the network unit 21 for the determined path so as to establish the demand.

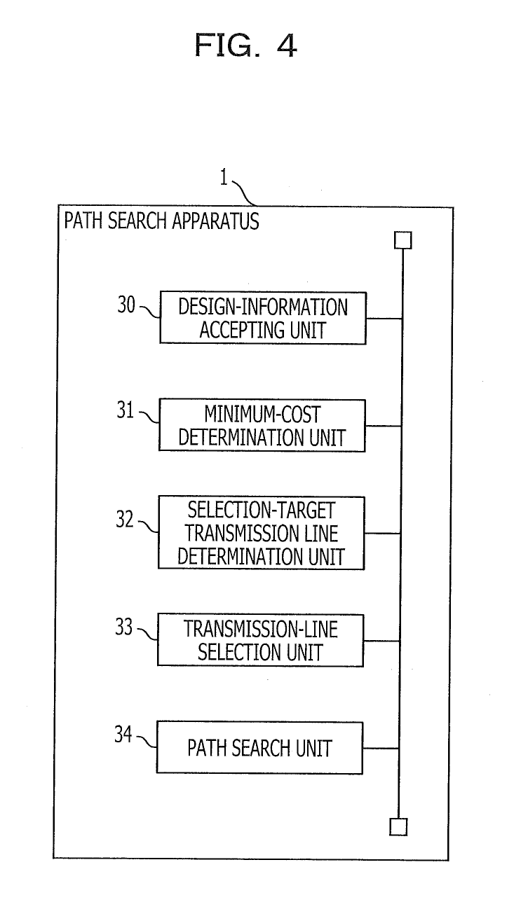

FIG. 4 is a diagram illustrating an example of a configuration of a path search apparatus. The processor 2 in FIG. 2 performs cooperative operation with the other hardware elements in the path search apparatus 1, as preferred, along with the path search program 10 stored in the auxiliary storage unit 4 so as to perform information processing through the individual elements illustrated in FIG. 4. The path search apparatus 1 includes a design-information accepting unit 30, a minimum-cost determination unit 31, a selection-target transmission line determination unit 32, a transmission-line selection unit 33, and a path search unit 34.

The design-information accepting unit 30 accepts demand information that is input through any one of the input unit 5, the removable-media reading unit 7, or the network interface 8. The demand information may include, for example, a start node and an end node of a demand, and a demand bandwidth. The input demand information is stored in the auxiliary storage unit 4 as a part of the design information 11.

In the following, a description will be given of processing with circuit capacity design that accommodates a demand that has the nodes N1 and N5 as a start node and an end node, respectively, in the transmission network illustrated in FIG. 1 that includes nodes N1 to N11, as an example of processing performed in the present embodiment.

The minimum-cost determination unit 31 carries out a shortest path search with the end node of the demand as a start point and each node on a physical topology as an end point on a physical topology in which exchange stations and physical connections on the transmission network correspond to nodes and links, respectively. The minimum-cost determination unit 31 determines a minimum cost from the end node to the individual nodes of the demand.

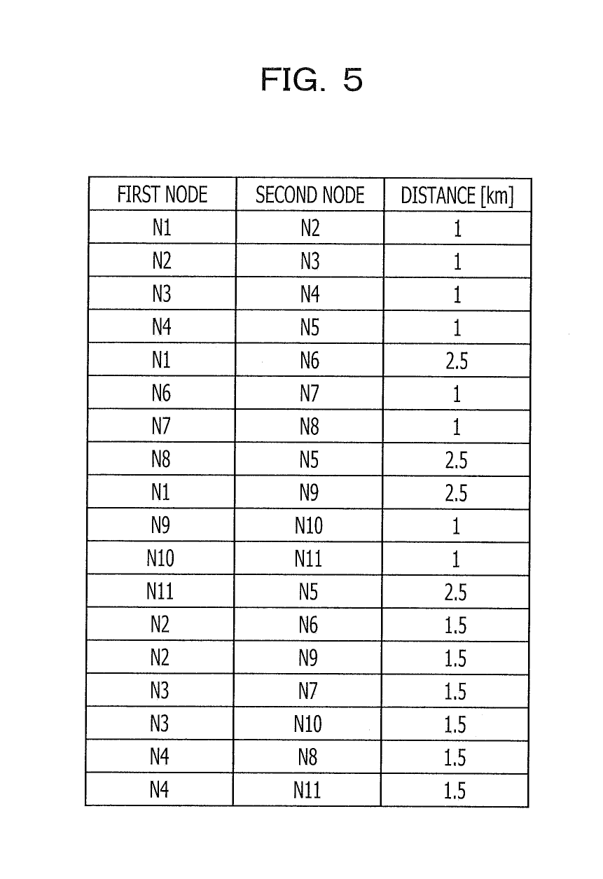

FIG. 5 is a diagram illustrating an example of physical connection information. The physical connection information is information on each physical connection constructed among nodes corresponding to exchange stations in a transmission network, and is stored in the auxiliary storage unit 4 as design information 11. The physical connection information includes as information elements information specifying a “first node” and a “second node”, which are both end nodes of the physical connection, and a “distance” of the physical connection constructed between these nodes. In another embodiment, either in place of the information element “distance” or in addition to the information element “distance”, the physical connection information may include information on another index to be used as a cost when the minimum-cost determination unit 31 performs cost calculation by shortest path search.

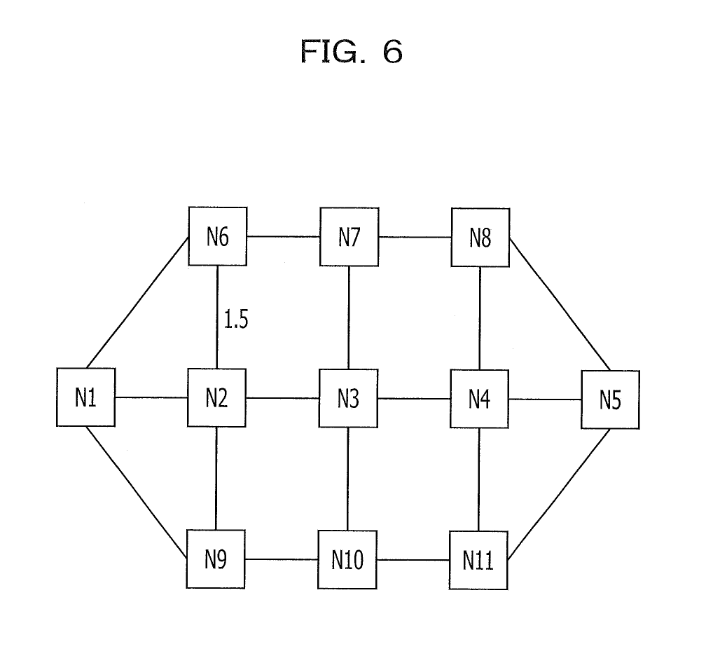

FIG. 6 is an explanatory diagram of a physical topology of a transmission network corresponding to the physical connection information in FIG. 5. For example, physical connection information in FIG. 5 indicates that a physical connection having a first node and a second node as “N2” and “N6”, respectively, is constructed between nodes N2 and N6, and a distance thereof is “1.5 km”.

Referring to FIG. 4, the minimum-cost determination unit 31 carries out a shortest path search by assuming the end node N5 of the demand is a start point, and each node other than the end node of the demand among the nodes N1 to N11 is an end point on the physical topology defined by the physical connection information. The minimum-cost determination unit 31 determines each path cost determined by the shortest path search to be a minimum cost from the end node N5 to the individual nodes. In the present embodiment, the minimum cost may be the shortest distance, for example, from the end node N5 to the individual nodes. This is similar for the other embodiments described below in the present specification. In addition, the minimum cost may be expressed by another index used as a cost in the cost calculation carried out in the shortest path search. The minimum-cost determination unit 31 records the determined shortest distance information in a table stored in the auxiliary storage unit 4.

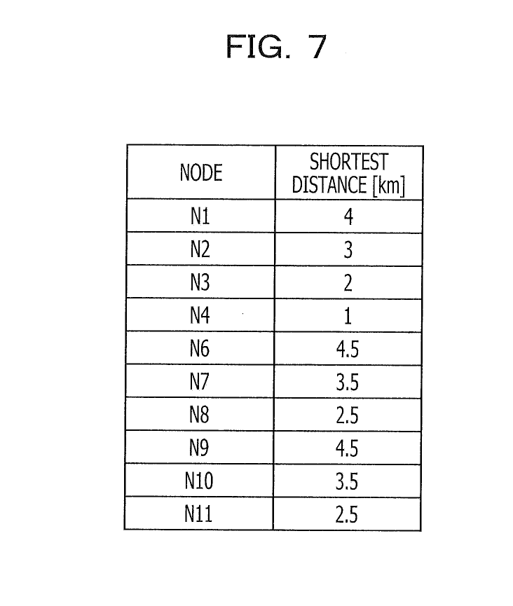

FIG. 7 is a diagram illustrating an example of shortest distance information from the end node N5 of the demand to the individual nodes N1 to N4 and N6 to N11. For example, the shortest path from the end node N5 to the node N1 on the physical topology is a path going through the nodes N5, N4, N3, N2 and N1. The distances between the individual nodes are “1 km” according to the physical connection information in FIG. 5. Accordingly, the shortest distance from the end node N5 to the node N1 is 4 km.

The transmission-line selection unit 33 selects a TDM transmission line, from the TDM transmission lines disposed in the transmission network, as a target of path search for a path to accommodate a demand. In the following description, a TDM transmission line is expressed simply as a “transmission line”. The transmission lines disposed in the transmission network are specified by transmission line information and route information that are stored in the auxiliary storage unit 4 as the design information 11.

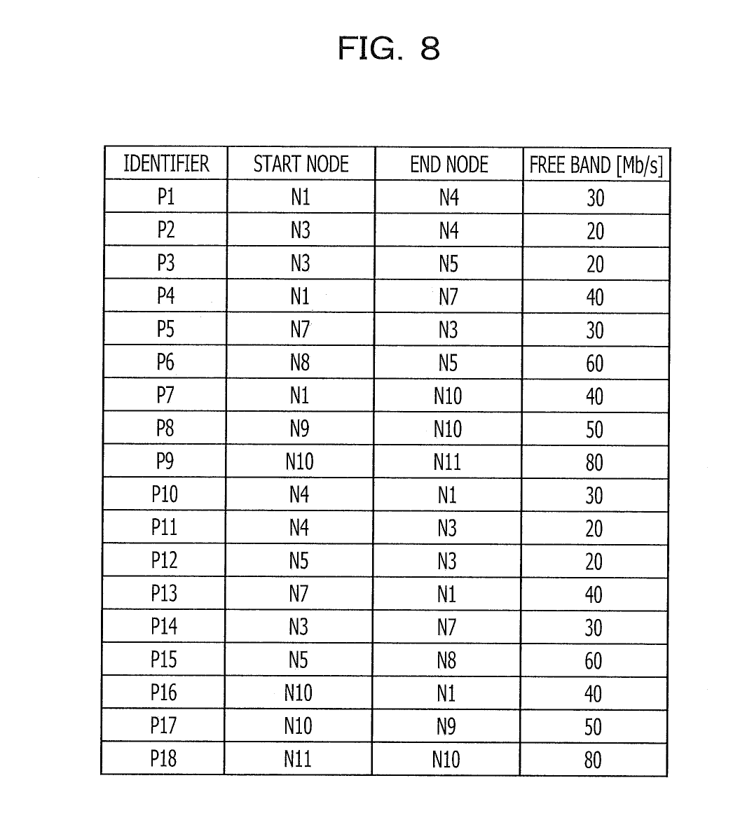

FIG. 8 is a diagram illustrating an example of transmission line information. The transmission line information includes as information elements an “identifier” which identifies individual transmission lines, a “start node” and an “end node” for each individual transmission line, and “free bandwidth” that can be accommodated in the transmission line. In this regard, a start node and an end node are defined in the transmission line information so that a direction for each transmission line is indicated. In the following description, a direction indicated by the transmission line information is expressed as an “indicated direction”. For an indicated direction, for example, a direction from a start node to an end node may be assumed to be the forward direction, and a direction from an end node to a start node may be assumed to be the opposite direction.

For example, transmission line P1 has the nodes N1 and N4 as start node and end node, respectively, and free capacity is 30 Mb/s. For example, the transmission line P2 has the nodes N3 and N4 as start node and end node, respectively, and free capacity is 20 Mb/s. A transmission line capable of transmitting a main signal bidirectionally may have transmission line information that defines a pair of transmission lines having transmission directions opposite to each other. For example, transmission lines P1 and P10 may have transmission line information that defines bidirectional transmission lines disposed between the nodes N1 and N4, which are both end-points. This is the same for transmission lines P2 and P11, transmission lines P3 and P12, transmission lines P4 and P13, transmission lines P5 and P14, transmission lines P6 and P15, transmission lines P7 and P16, transmission lines P8 and P17, and transmission lines P9 and P18.

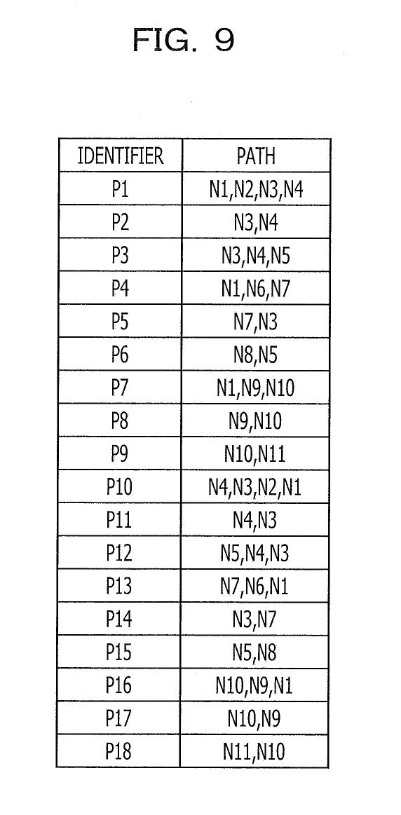

FIG. 9 is a diagram illustrating a first example of route information. Route information specifies nodes that a transmission line goes through, and an arrangement order for arranging nodes on the transmission line in an indicated direction. In an example illustrated in FIG. 9, route information has an “identifier” for a transmission line and an information element “path”. The information element “path” has a list of nodes arranged in order of an indicated direction of nodes through which the transmission line passes. In the same manner as the transmission line information, route information may be determined such that a transmission line capable of transmitting a bidirectional main signal is defined as a pair of transmission lines having opposite transmission directions. Transmission line information and route information may be contained in one table.

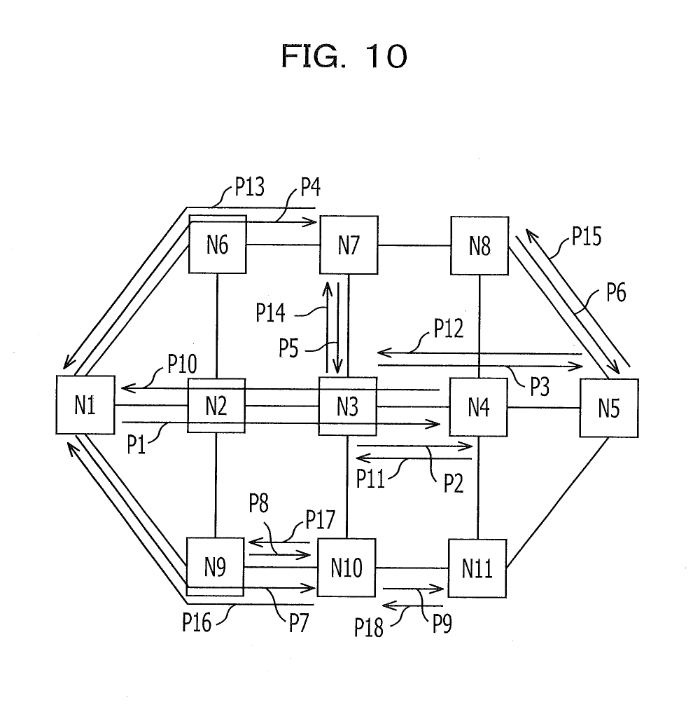

FIG. 10 illustrates an example of setting transmission lines determined by the route information in FIGS. 8 and 9. For example, transmission line P1 is a transmission line having nodes N1 and N4 as a start node and an end node, respectively, and arranging transmission P1's nodes N1, N2, N3 and N4 in the arrangement order that the indicated direction of the transmission line P1 indicates gives the order of the nodes as N1, N2, N3 and N4. Further, for example, transmission line P10 has the nodes N4 and N1 as a start node and an end node, respectively, and arranging transmission line P10's nodes N1, N2, N3 and N4 in the arrangement order that the indicated direction of transmission line P10 indicates gives the order of the nodes as N4, N3, N2 and N1. The nodes N1 to N4 belonged to P1 and P10.

For example, transmission line P3 is a transmission line having the nodes N3 and N5 as a start node and an end node, respectively, and arranging transmission line P3's nodes N3, N4 and N5 in the arrangement order that the indicated direction of transmission line P3 indicates gives the order of the nodes as N3, N4 and N5. Further, for example, transmission line P12 is a transmission line having the nodes N5 and N3 as a start node and an end node, respectively, and arranging transmission line P12's nodes N3, N4 and N5 in the indicated direction of the transmission line P12 gives the order of the nodes as N5, N4 and N3.

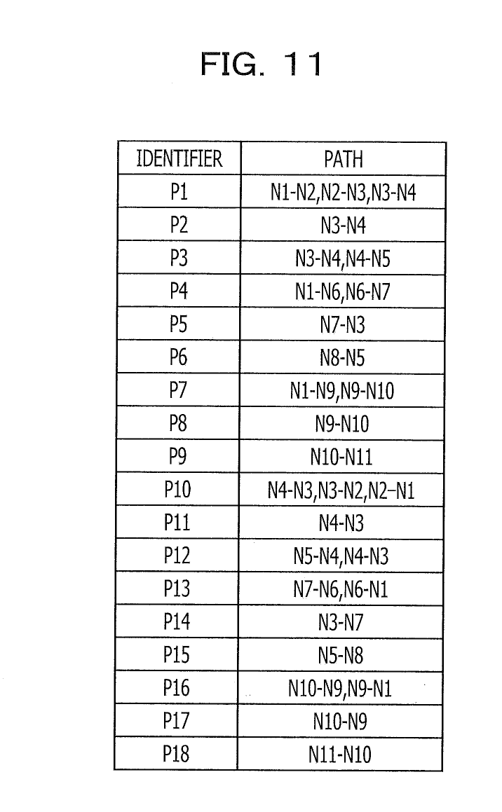

FIG. 11 is a diagram illustrating a second example of route information. The route information has an “identifier” of a transmission line and an information element “path”. The information element “path” may have a list of links arranged in order of an indicated direction of links on a physical topology through which the transmission line passes.

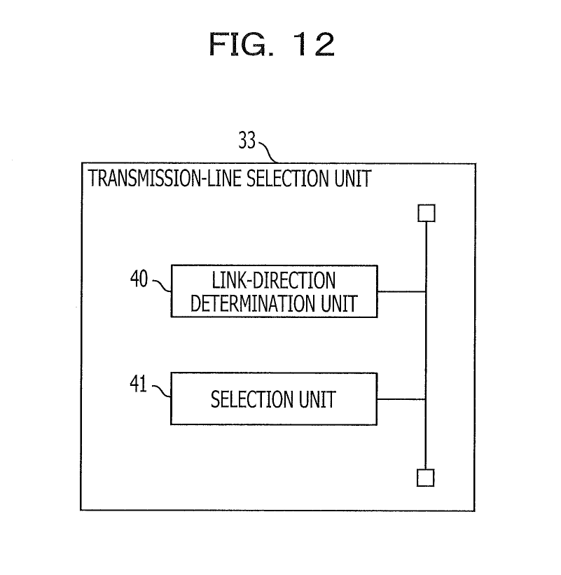

FIG. 12 is a diagram illustrating an example of a first configuration of the transmission-line selection unit 33. The transmission-line selection unit 33 includes a link-direction determination unit 40 and a selection unit 41. For each link on the physical topology in the transmission network, the link-direction determination unit 40 determines the link direction in accordance with the shortest distance from a demand's end node to both end nodes of the link. The link direction is regarded as forward if the direction is from a node whose shortest distance is a higher value than the shortest distance of the other node. For example, with a link between nodes N3 and N4, according to the shortest distance information illustrated in FIG. 7, node N3's shortest distance of “2 km” is longer than node N4's shortest distance of “1 km”. Accordingly, the direction of the link between nodes N3 and N4 is the direction from node N3 to node N4.

The link-direction determination unit 40 performs exception processing that determines the link direction for a link that includes the start node N1 in the demand. With a link that includes the start node N1 in the demand, a direction from the start node N1 to the other end's node is assumed to be forward. The link-direction determination unit 40 generates link direction information that identifies a determined link direction for each link, and stores the link direction information into the auxiliary storage unit 4.

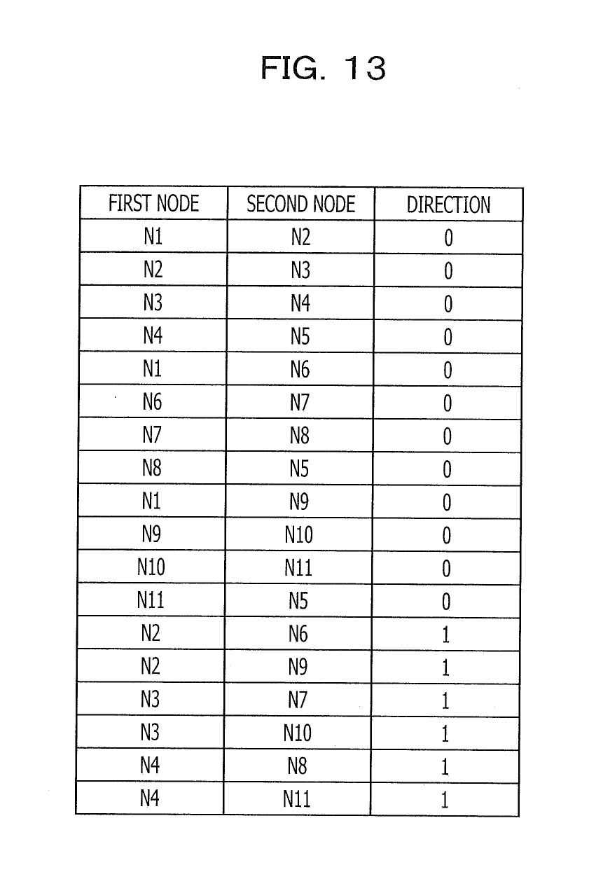

FIG. 13 is an explanatory diagram for link direction information. Link direction information includes, as information elements, a “first node” and a “second node”, which both become end nodes for individual links on the physical topology, and a “direction”, which indicates the direction of each link. The information element “direction” has a value “0” if the direction from the first node to the second node is equal to the link's direction and a value “1” if the direction from the first node to the second node is opposite to the link's direction. In other embodiments, an expression other than “0” and “1” may be used.

Referring to FIG. 12, the selection unit 41 determines, for each transmission line specified in the transmission line information, whether or not the arrangement order from arranging a plurality of nodes on the transmission line in the indicated direction is equal to the order among a plurality of nodes determined in accordance with the shortest distance from the demand's end node to the plurality of nodes on the transmission line.

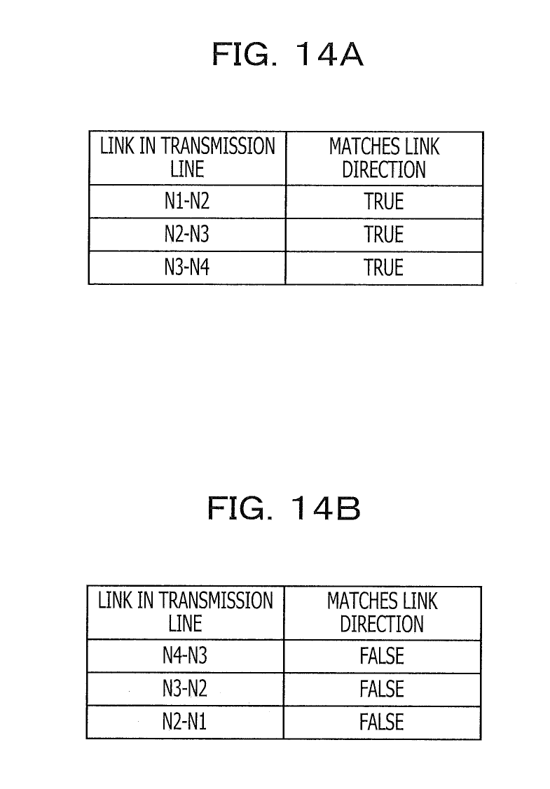

In a certain embodiment, for each transmission line specified in the transmission line information, the selection unit 41 generates a list of links that are included in the transmission line. Then, for each link included in a transmission line, the selection unit 41 determines whether or not the link's direction as specified in the link direction information matches the transmission line's indicated direction. With reference to FIG. 14A, a description will be given of an example of a result of comparison between transmission line direction and link direction for the transmission line P1. FIG. 14A is a list of links included in the transmission line P1 and includes a link from the node N1 to the node N2, a link from the node N2 to the node N3, and a link from the node N3 to the node N4.

As illustrated in FIG. 9, the indicated direction of the transmission line P1 is the direction from the node N1 to the node N2, the direction from the node N2 to the node N3, and the direction from the node N3 to the node N4. As illustrated in FIG. 13, the direction of the link having the nodes N1 and N2 as both ends is the direction from the node N1 to the node N2. In addition, the direction of the link having the nodes N2 and N3, and the direction of the link having the nodes N3 and N4 is from the node N2 to the node N3, and from the node N3 to the node N4, respectively. Accordingly, the direction of the transmission line matches the direction of the links, and thus a value “TRUE” indicating that the direction of the transmission line matches the direction of the link is added to each link included in the list.

With reference to FIG. 14B, a description will be given of an example of a result of comparison between the transmission line direction and the link direction for the transmission line P10. FIG. 14B is a list of links that are included in the transmission line P10 and includes a link from the node N4 to the node N3, a link from the node N3 to the node N2, and a link from the node N2 to the node N1.

The indicated direction of the transmission line P10 is the direction from the node N4 to the node N3, the direction from the node N3 to the node N2, and the direction from the node N2 to the node N1. However, link directions of the link having the nodes N1 and N2 as both ends, the link having the nodes N2 and N3 as both ends, and the link having the nodes N3 and N4 as both ends are each opposite to the indicated direction. Accordingly, a value “FALSE” indicating that the direction of the transmission line does not match the direction of the link is added to each link included in the list.

The selection unit 41 selects, from the transmission lines specified in the transmission line information, only transmission lines that have the same arrangement order when arranging nodes on the transmission line in the indicated direction as the order among a plurality of nodes determined in accordance with the shortest distance from the demand's end node to the plurality of nodes. In a certain embodiment, of all the links included in the transmission line, the selection unit 41 selects only transmission lines whose indicated direction matches the link direction. For example, as illustrated in FIG. 14A, the indicated direction matches the link direction for all the links included in the transmission line P1, and thus the selection unit 41 selects the transmission line P1. On the other hand, as illustrated in FIG. 14B, the links included in the transmission line P10 includes a link whose link direction does not match the indicated direction, and thus the selection unit 41 does not select the transmission line P10.

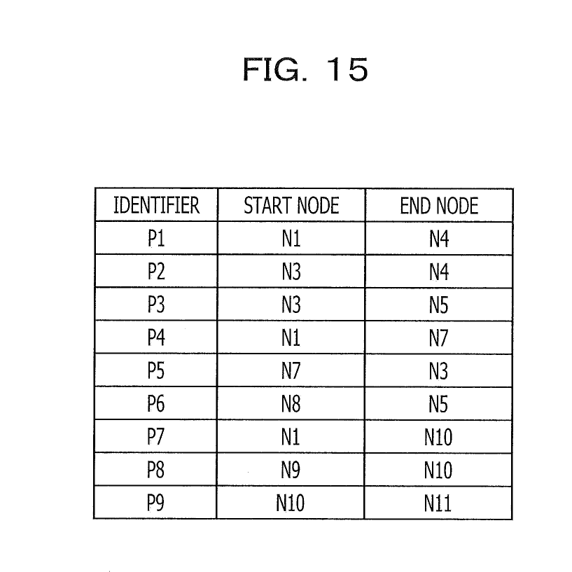

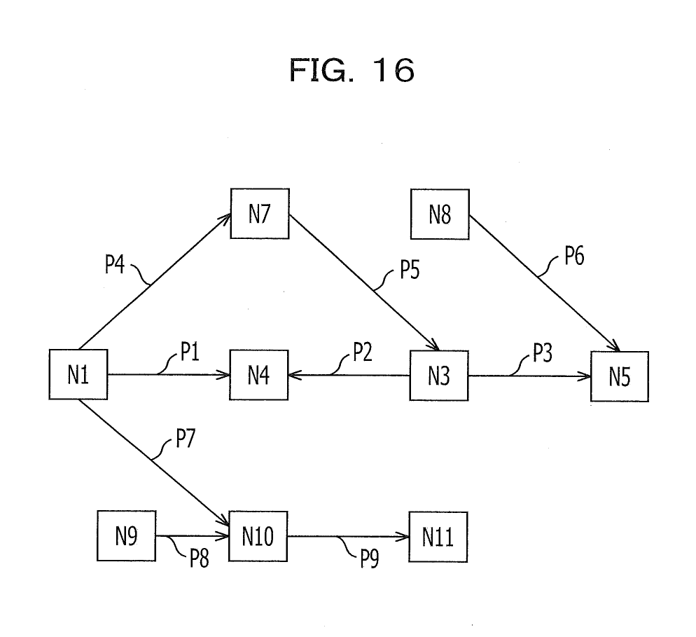

FIG. 15 is an explanatory diagram of transmission lines selected by the transmission-line selection unit 33. Of the transmission lines P1 to P18 specified in the transmission line information in FIG. 8, only the transmission lines P1 to P9 are selected by the transmission-line selection unit 33. FIG. 16 is an explanatory diagram of a logical topology formed by the selected transmission lines P1 to P9. Arrows of the links corresponding to the individual transmission lines P1 to P9 indicate each individual transmission line's indicated direction.

Referring to FIG. 4, the selection-target transmission line determination unit 32 determines which transmission lines out of the transmission lines specified in the transmission line information are to be targets of selection processing by the transmission-line selection unit 33. For example, the selection-target transmission line determination unit 32 may select, as a target of selection processing by the transmission-line selection unit 33 out of the transmission lines specified in the transmission line information, only a transmission line that has free bandwidth higher than the demand's bandwidth. As a result, transmission lines that are not capable of providing the demand bandwidth are excluded from a population of transmission lines for selection processing, which is performed by the above-mentioned selection unit 41, and wasteful selection processing may be avoided.

The path search unit 34 searches for a path to accommodate the demand, in other words searches for the shortest path from the start node to the end node of the demand on the logical topology, which is formed by the transmission lines P1 to P9 selected by the transmission-line selection unit 33. At this time, the path search unit 34 selects only paths that go in the same direction as the indicated direction of the transmission line. For example, in an example of the logical topology illustrated in FIG. 16, in a section between the nodes N3 and N4, the path search unit 34 may select a path from the node N3 to the node N4, but is not possible to select a path from the node N4 to the node N3.

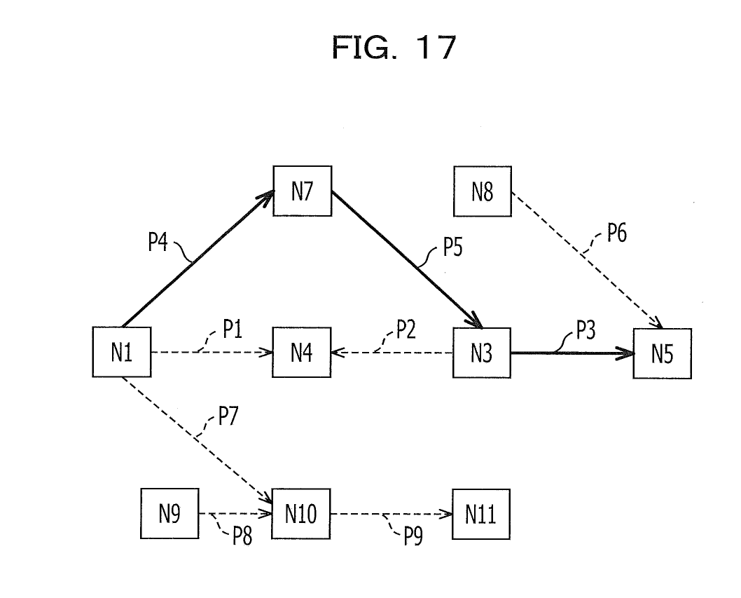

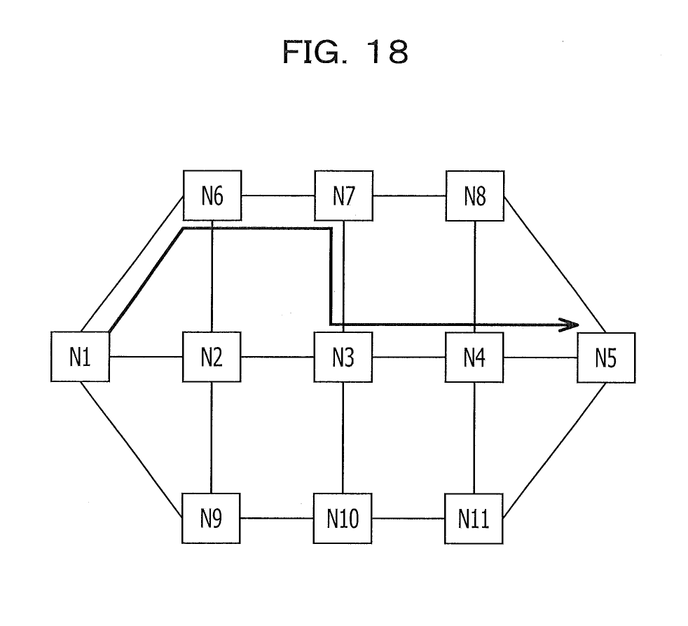

An example of a path that accommodates the demand that is searched for by the path search unit 34 is illustrated by a bold solid line on the logical topology in FIG. 17. In addition, a path on the physical topology that corresponds to the path in FIG. 17 is illustrated in FIG. 18. The path includes the transmission lines P4, P5 and P3, and passes the nodes N1, N6, N7, N3, N4 and N5 in that order. As is understood from the path on the physical topology illustrated in FIG. 18, a path that does not include a plurality of overlapping transmission lines in the same section is obtained. The path search unit 34 outputs the search result of the path, for example, in the form of a list of a series of transmission lines that form the path.

### 1.2 Processing

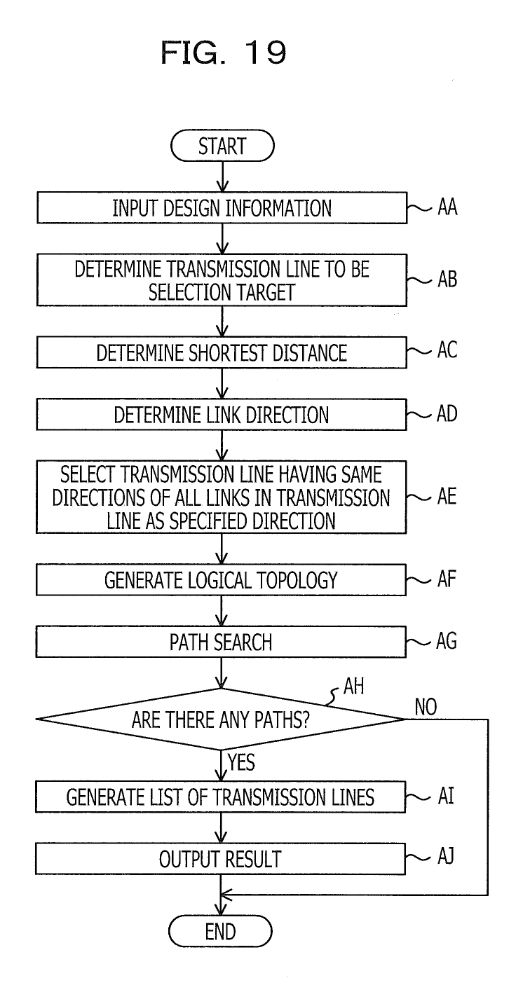

Next, a description will be given of processing performed by the path search apparatus 1. FIG. 19 is an explanatory diagram of a first example of path search processing. In this regard, the following operations AA to AJ may be steps used in other embodiments.

In operation AA, the design-information accepting unit 30 accepts input of design information 11, and stores the design information 11 into the auxiliary storage unit 4. If part of the design information 11 is stored in the auxiliary storage unit 4 in advance, input of the design information 11 may be omitted. In operation AB, for each transmission line specified in the transmission line information, the selection-target transmission line determination unit 32 determines whether the transmission line is to be a target of the selection processing, which is performed by the transmission-line selection unit 33.

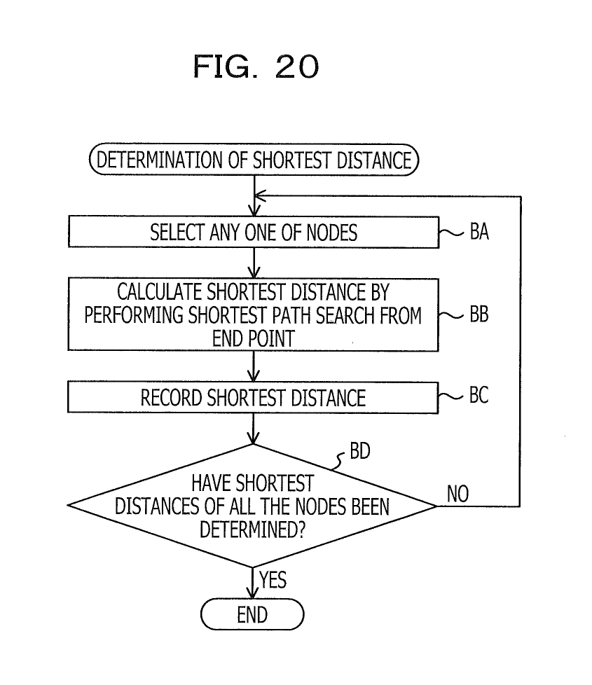

In operation AC, the minimum-cost determination unit 31 determines the shortest distance from the end node of the demand to each node on the physical topology in the transmission network. FIG. 20 is an explanatory diagram illustrating a first example of determination processing of shortest distance. In this regard, in other embodiments, the following operations BA to BD may be steps.

In operation BA, the minimum-cost determination unit 31 selects a node on the physical topology, on which determination processing of the shortest path has not been performed. In operation BB, the minimum-cost determination unit 31 carries out the shortest path search with the demand's end node as the start point, and with the node selected in operation BA as the end point, and determines the shortest distance.

In operation BC, the minimum-cost determination unit 31 records the determined shortest distance information in a table stored in the auxiliary storage unit 4. In operation BD, the minimum-cost determination unit 31 determines whether or not shortest distances have been determined for all the nodes. If shortest distances have been determined for all the nodes (operation BD: Y), the processing is terminated. If there is a node whose shortest distance has not been determined (operation BD: N), the processing returns to operation BA.

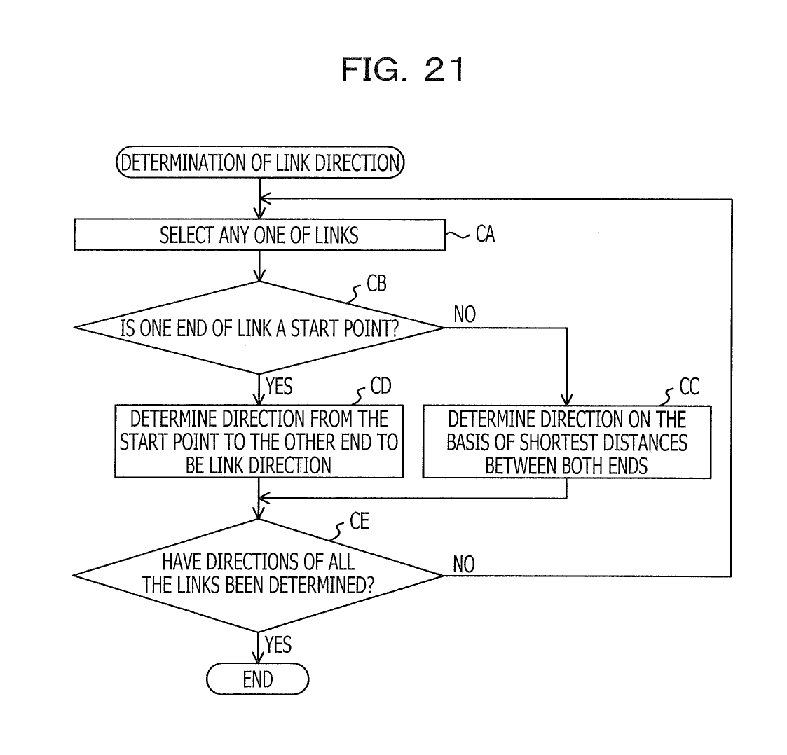

Referring to FIG. 19, in operation AD, the link-direction determination unit 40 of the transmission-line selection unit 33 determines, for each link on the physical topology, link direction in accordance with the shortest distance from the demand's end node to both end nodes of the link. FIG. 21 is an explanatory diagram of a first example of determination method for a link direction. In this regard, in other embodiments, the following operations CA to CE may be steps.

In operation CA, the link-direction determination unit 40 selects a links on the physical topology, on which link-direction determination processing has not yet been performed. In operation CB, the link-direction determination unit 40 determines whether or not one end node of the selected link is the start node of the demand. If one end node of the selected link is the demand's start node (operation CB: Y), the processing proceeds to operation CD. If neither end node of the selected link is the start node (operation CB: N), the processing proceeds to operation CC.

In operation CC, the link-direction determination unit 40 determines link direction in accordance with the shortest distance from the end node of the demand to both end nodes of the link. After that, the processing proceeds to operation CE. In operation CD, the link-direction determination unit 40 determines the direction from the demand's start node to the other end node of the link to be the link direction. After that, the processing proceeds to operation CE. In operation CE, the link-direction determination unit 40 determines whether or not a direction has been determined for all the links. If direction has been determined for all the links (operation CE: Y), the processing is terminated. If there is a link whose direction has not been determined (operation CE: N), the processing returns to operation CA.

Referring to FIG. 19, in operation AE, the selection unit 41 determines, for each transmission line specified in the transmission line information, whether or not the direction of each link included in the transmission line matches the indicated direction of the transmission line. The selection unit 41 selects a transmission line whose links all have direction equal to the indicated direction.

In operation AF, the path search unit 34 generates a logical topology formed only by the transmission lines selected by the selection unit 41. In operation AG, the path search unit searches for a path to accommodate the demand in that the path search unit 34 searches for a path from the start node to the end node of the demand through transmission lines that is in order according to the indicated direction on the logical topology. If a path is found (operation AH: Y), the processing proceeds to operation AI. If a path is not found (operation AH: N), a determination is made that there is no path that accommodates the demand, and the processing is terminated.

In operation AI, the path search unit 34 generates a list of transmission lines that the found path uses. In operation AJ, the path search unit 34 outputs a list of transmission lines as a result of the path search.

According to the present embodiment, when searching for a transmission line to accommodate a demand, it is possible to obtain a search result that has no overlapping transmission lines in the same section. In a network that transmits through a TDM transmission line using a WDM technique, part of the WDM optical path is not transformed into an electric signal by an exchange station in partway through the transmission line, and thus an optical signal may pass through directly. In such a network, a physical topology representing a physical connection relationship of physical connections between exchange stations does not match the logical topology of transmission lines on which the path search is performed. Accordingly, in a related-art circuit capacity design, a path is sometimes selected on a plurality of overlapping transmission lines in a same section. In the present embodiment, the order of individual nodes is determined in accordance with the order of minimum cost from the end node of a demand to each node, and the path search is performed from among transmission lines that have the same direction as this order. Accordingly, it is possible both to avoid selecting a path that includes a portion that doubles back and to obtain a search result that has no overlapping transmission lines in a same section.

In this regard, in the above-described embodiment, the minimum-cost determination unit 31 determines a minimum cost from the end node of a demand to individual nodes. In other embodiments, the minimum-cost determination unit 31 may instead determine a minimum cost from the start node of a demand to individual nodes. At this time, the transmission-line selection unit 33 selects as a transmission line on which a path search is performed only a transmission line whose nodes are arranged in the order of an indicated direction that is equal to a node order determined in accordance with the shortest distance from the start node of a demand to individual nodes on the transmission line. In other embodiments described below, modifications may be made such that the minimum-cost determination unit 31 determines a minimum cost from the start node to individual nodes in the same manner.

### 2. Second Embodiment

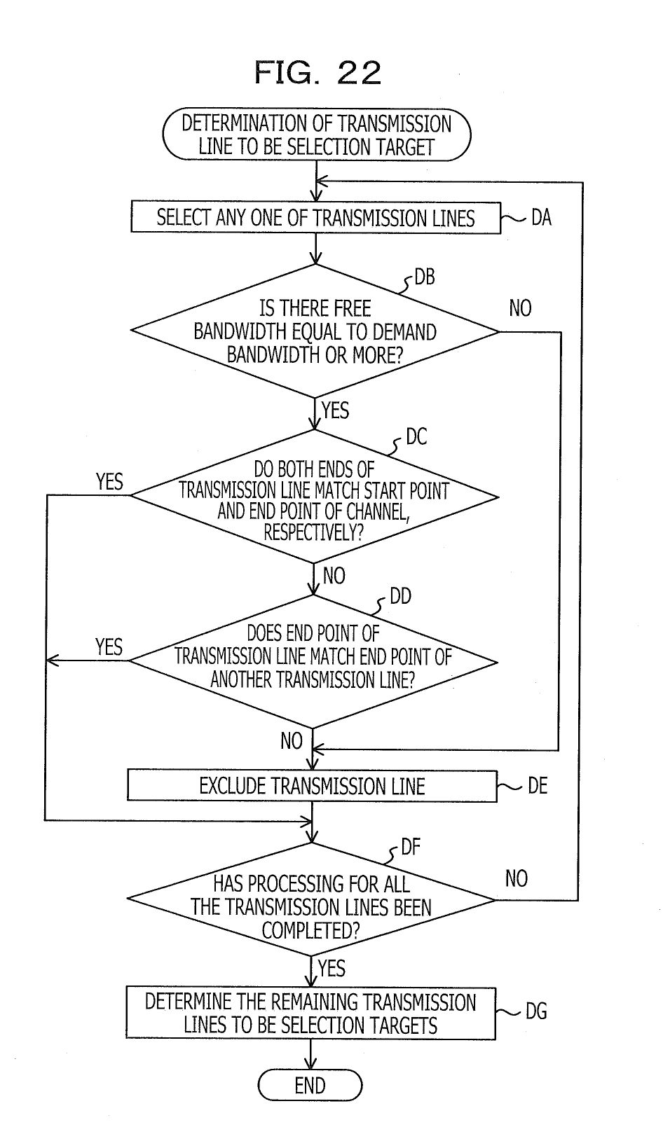

Next, a description is given of a path search apparatus 1 according to another embodiment. In the present embodiment, the selection-target transmission line determination unit 32 determines targets of the selection processing by the transmission-line selection unit 33 by selecting only a transmission line wherein at least one of the transmission line's start point or end point is coupled to another transmission line. In other embodiments described below, the selection-target transmission line determination unit 32 may determine that a transmission line is a selection target in the same manner. FIG. 22 is an explanatory diagram of an example of the other processing performed by the selection-target transmission line determination unit 32. In other embodiments, the following operations DA to DG may be steps.

In operation DA, the selection-target transmission line determination unit 32 selects a transmission line, on which the selection-target transmission line determination processing has not been performed, from the transmission lines specified by the transmission line information. In operation DB, the selection-target transmission line determination unit 32 determines whether or not the transmission line has free bandwidth greater than or equal to a demand bandwidth. If the transmission line has free bandwidth greater than or equal to a demand bandwidth (operation DB: Y), the processing proceeds to operation DC. If the transmission line does not have free bandwidth greater than or equal to a demand bandwidth (operation DB: N), the processing proceeds to operation DE.

In operation DC, the selection-target transmission line determination unit 32 determines whether or not the ends of the transmission line match the start node and the end node of the demand. If the ends of the transmission line match the start node and the end node of the demand (operation DC: Y), the processing proceeds to operation DF. If the ends of the transmission line do not match the start node and the end node of the demand, respectively (operation DC: N), the processing proceeds to operation DD.

In operation DD, the selection-target transmission line determination unit 32 determines whether or not one of the end points of the transmission line matches an end point of another transmission line. If one of the end points of the transmission line matches an end of another transmission line (operation DD: Y), the processing proceeds to operation DF. If neither end of the transmission line matches an end of another transmission line (operation DD: N), the processing proceeds to operation DE.

In operation DE, the selection-target transmission line determination unit 32 excludes the current transmission line from being a target of the selection processing by the transmission-line selection unit 33. In operation DF, the selection-target transmission line determination unit 32 determines whether or not the selection-target transmission line determination processing has been performed for all the transmission lines. If the selection-target transmission line determination processing has been performed for all the transmission lines (operation DF: Y), the processing proceeds to operation DG. If there is a transmission line on which the selection-target transmission line determination processing has not yet been performed (operation DF: N), the processing returns to operation DA. In operation DG, the selection-target transmission line determination unit 32 determines that a transmission line that has been left without having been excluded by operation DE is the selection target.

By the present embodiment, it becomes possible to exclude from the path search processing by the path search unit 34 a transmission line that is isolated from other transmission lines and is not possible to be used to accommodate a demand. Accordingly, by the present embodiment, it becomes possible to reduce memory and processing time that are used for path search.

### 3. Third Embodiment

Next, a description will be given of a path search apparatus 1 according to another embodiment. In the above-described first embodiment, when determining link direction on the physical topology, for a link that includes the start node of a demand, exception processing is performed to specify a direction from the start node to another node as the forward direction. In the present embodiment, when determining a link direction, a value for the start node is set to the shortest distance value of the start node such that a direction from the start node to another terminal node becomes a forward direction.

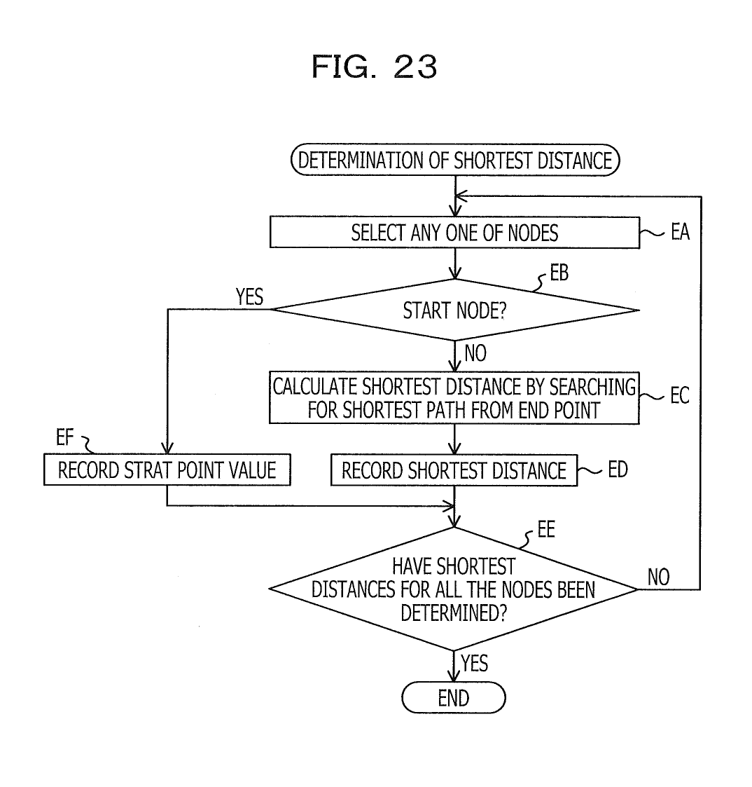

FIG. 23 is an explanatory diagram illustrating a second example of a method for determining the shortest distance. In other embodiments, the following operation EA to EF may be steps.

In operation EA, the minimum-cost determination unit 31 selects a node on the physical topology, on which the shortest-path determination processing has not been performed yet. In operation EB, the minimum-cost determination unit 31 determines whether or not the node is the start node of the demand. If the node is the start node of the demand (operation EB: Y), the processing proceeds to operation EF. If the node is not the start node of the demand (operation EB: N), the processing proceeds to operation EC.

The processing of operation EC and ED is the same as the processing of operation BB and BC illustrated in FIG. 20, and description thereof is omitted. In operation EE, the minimum-cost determination unit 31 determines whether or not a shortest distance has been determined for all the nodes. If a shortest distance has been determined for all the nodes (operation EE: Y), the processing is terminated. If there is a node whose shortest distance has not been determined (operation EE: N), the processing returns to operation EA.

In operation EF, the minimum-cost determination unit 31 records a value for the start node, which is a value for node shortest distance. The value for a start node may be, for example, the sum of a positive fixed value and the shortest distance of a farthest node that is obtained when searching for the shortest path, or a value produced by multiplying the shortest distance for the farthest node by a fixed value greater than 1. In addition, the value for the start node may be, for example, the sum of a positive fixed value and the total length of all the links on the physical topology, or a value produced by multiplying the total length by a fixed value greater than 1. Also, the value for the start node may instead be the sum of a positive fixed value and the shortest distance value of a node having a longest shortest distance out of the nodes coupled to the start node by a link, or a value produced by multiplying the longest shortest distance value by a fixed value greater than 1, or a maximum value from numerical calculation determined by software, or so on. After operation EF, the processing proceeds to operation EE.

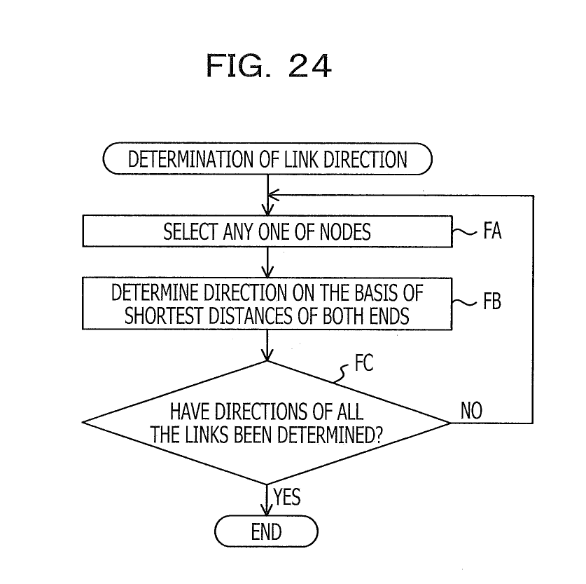

FIG. 24 is an explanatory diagram of a second example of a method of determining a link direction. In this regard, in other embodiments, the following operations FA to FC may be steps. The processing in operations FA, FB and FC is the same as the processing in operations CA, CC and CE illustrated in FIG. 21, and description thereof is omitted.

According to the present embodiment, when determining a link direction on the physical topology, it is possible to omit exception processing of a link that includes a start node of a demand, which is performed in the first embodiment.

### 4. Fourth Embodiment

Next, a description will be given of a path search apparatus 1 according to another embodiment. In the present embodiment, processing for when shortest distances for nodes at both ends of a link on a physical topology are equal is added. A first option, for a transmission line that includes a link having an equal shortest distance value at both end nodes, is processing that does not select the transmission line to form a logical topology on which the path search is performed. A second option is processing that allows selection of a transmission line that includes a link having an equal shortest distance value at both end nodes when forming a logical topology.

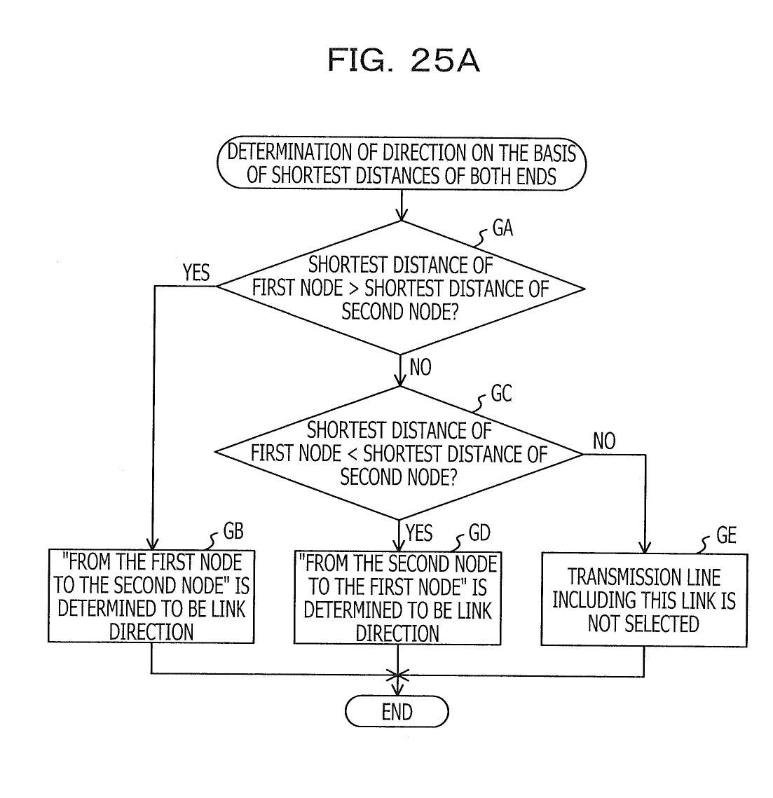

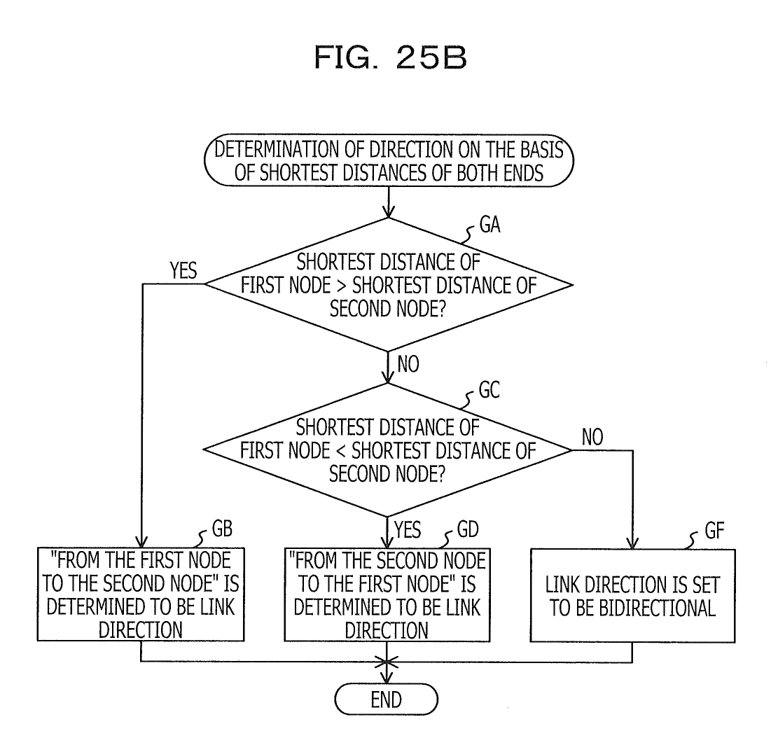

FIG. 25A and FIG. 25B are explanatory diagrams of processing examples for the first option and the second option, respectively. In this regard, in other embodiments, the following operation GA to GF may be steps.

In operation GA, the link-direction determination unit 40 determines whether or not the shortest distance of a first node of the link is greater than the shortest distance of the second node. If the shortest distance of the first node is greater than the shortest distance of the second node (operation GA: Y), the processing proceeds to operation GB. If the shortest distance of the first node is not greater than the shortest distance of the second node (operation GA: N), the processing proceeds to operation GC. In operation GB, the link-direction determination unit 40 determines that the link direction is the direction from the first node to the second node. After operation GB, the processing is terminated.

In operation GC, the link-direction determination unit 40 determines whether or not the shortest distance of the first node of the link is less than the shortest distance of the second node. If the shortest distance of the first node is less than the shortest distance of the second node (operation GC: Y), the processing proceeds to operation GD. If the shortest distance of the first node is not less than the shortest distance of the second node (operation GC: N), the processing proceeds to operation GE. In operation GD, the link-direction determination unit 40 determines that the link direction is the direction from the second node to the first node. After operation GD, the processing is terminated.

With the first option, in operation GE, the link-direction determination unit 40 performs processing to prohibit the selection unit 41 from selecting a transmission line that includes the link. For example, the link-direction determination unit 40 prohibits creation of link direction information on this link. Alternatively, the link-direction determination unit 40 deletes link direction information for this link from the auxiliary storage unit 4. If there is no link direction information for this link, the selection unit 41 does not determine that this link direction matches the indicated direction of the transmission line including this link, and thus the selection unit 41 does not select a transmission line that includes this link.

In processing for the second option, if the shortest distance of the first node is not less than the shortest distance of the second node (operation GC: N), the processing proceeds to operation GF. In operation GF, the link-direction determination unit 40 specifies that the link direction is bidirectional. For example, the link-direction determination unit 40 specifies a value “2” that indicates bidirectional as a value of an information element “direction” of the link direction information. If a link direction is bidirectional, the selection unit 41 determines that the link direction matches the indicated direction of the transmission line regardless of the indicated direction of the transmission line.

Alternatively, for example, the link-direction determination unit 40 may individually generate link direction information for a direction from the first node to the second node and a direction from the second node to the first node.

With the first option, a transmission line going through a link whose nodes have equal minimum cost on the physical topology is excluded from being a path search target, and thus a path that might take a roundabout way is excluded. As a result, the memory and processing used for path search may be decreased. With the second option, the number of transmission lines included in a logical topology, on which path search is carried out, may increase, and thus it may be possible to increase the probability of finding a path search solution.

### 5. Fifth Embodiment

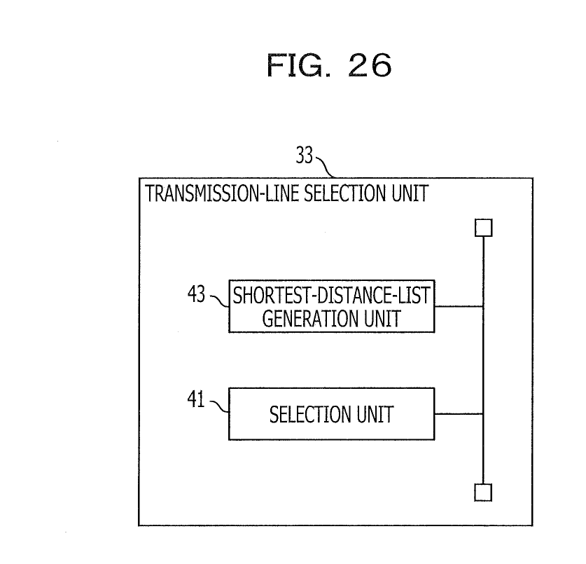

Next, a description will be given of a path search apparatus 1 according to another embodiment. FIG. 26 is a diagram illustrating an example of a second configuration of the transmission-line selection unit 33. The transmission-line selection unit 33 includes a selection unit 41 and a shortest-distance-list generation unit 43. The shortest-distance-list generation unit 43 generates a shortest distance list for each transmission line. The shortest distance list is a list in which individual shortest distances of the nodes on a transmission line are arranged in the same order as when nodes are arranged in an order given by the indicated direction.

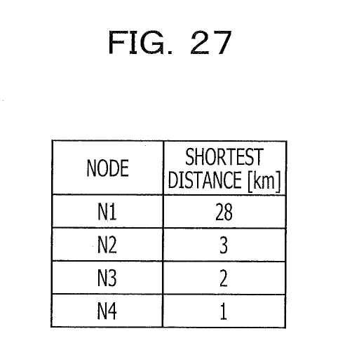

FIG. 27 is an explanatory diagram of an example of the shortest distance list for the transmission line P1. The shortest distance list includes the information elements “node” and a “shortest distance”. The information element “node” stores nodes included in the transmission line in the indicated direction order. With the transmission line P1, the arrangement order of nodes in the indicated direction is the order N1, N2, N3 and N4. The information element “shortest distance” specifies the shortest distance from the end node of the demand to each node.

The selection unit 41 selects each node from the shortest distance list individual nodes that is not an end node, and compares the shortest distance of the selected node with the shortest distance of the node next to this node on the end point side. If each node has a shortest distance that is greater than the shortest distance of the next node on the end point side, and the shortest distance of each node monotonously decreases in the direction from the start point to the end point, the selection unit 41 selects the corresponding transmission line.

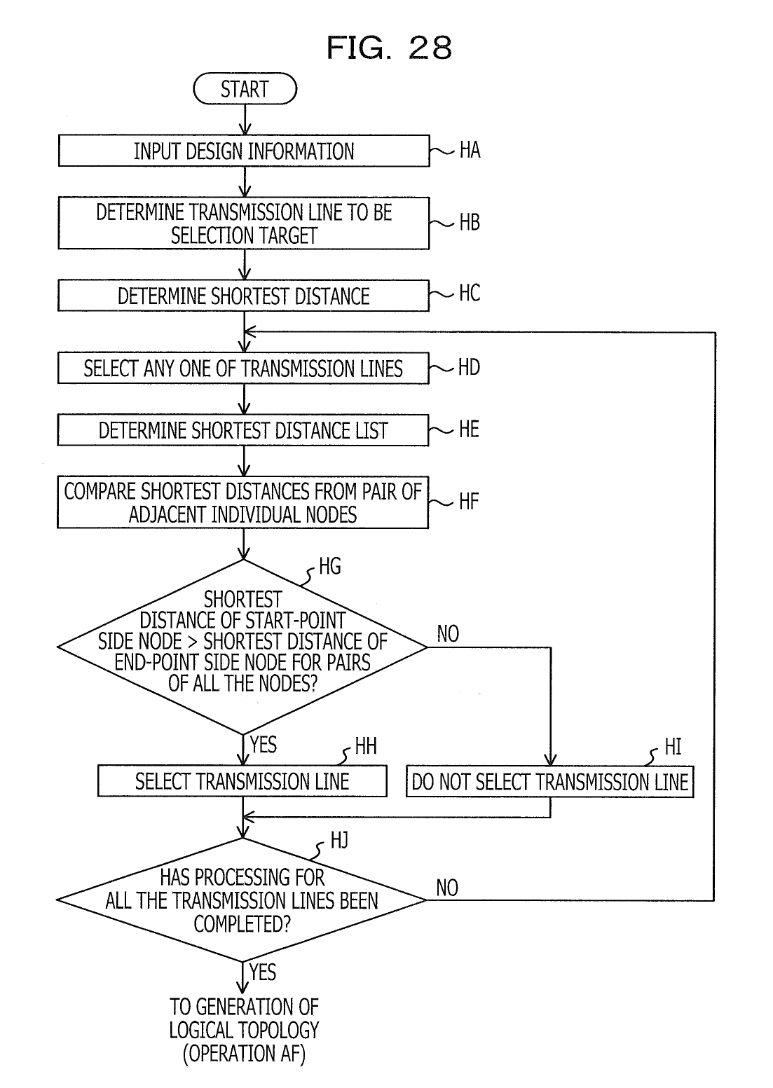

FIG. 28 is an explanatory diagram of a second example of the path search processing according to the present embodiment. In this regard, in other embodiments, the following operations HA to HJ may be steps. The processing of operation HA to HC is the same as the processing of operation AA to AC illustrated in FIG. 19, and description thereof is omitted.

In operation HD, the shortest-distance-list generation unit 43 selects a transmission line, whose shortest distance list has not been generated, from the transmission lines specified in the transmission line information. In operation HE, the node-list generation unit 44 determines the shortest distance list for the transmission line.

In operation HF, the selection unit 41 selects each individual node other than the end node, and compares shortest distances for each pair, consisting of a node and the node adjacent to it on the end point side. In operation HG, the selection unit 41 determines for each pair whether or not the shortest distance of the start-point side node is greater than the shortest distance of the end-point node. If the shortest distance of the start-point side node is greater than the shortest distance of the end-point node for each pair of nodes (operation HG: Y), the processing proceeds to operation HH. If the shortest distance of the start-point side node is not greater than the shortest distance of the end-point node in any pair of nodes (operation HG: N), the processing proceeds to operation HI.

In operation HH, the selection unit 41 selects the transmission line. Afterwards, the processing proceeds to operation HJ. In operation HI, the selection unit 41 does not select the transmission line. Afterwards, the processing proceeds to operation HJ. In operation HJ, the transmission-line selection unit 33 determines whether a shortest distance list has been generated for all the transmission lines. If a shortest distance list has been generated for all the transmission lines (operation HJ: Y), a path search is carried out by the same processing as the processing in operation AF to AJ illustrated in FIG. 19. If there is a transmission line for which the shortest distance list has not been generated yet (operation HJ: N), the processing returns to operation HD.

According to the present embodiment, it is possible to omit creation of the link direction information illustrated in FIG. 13, and thus it is possible to reduce the amount of data to be used for path search with a network that includes a large number of links on the physical topology.

### 6. Sixth Embodiment

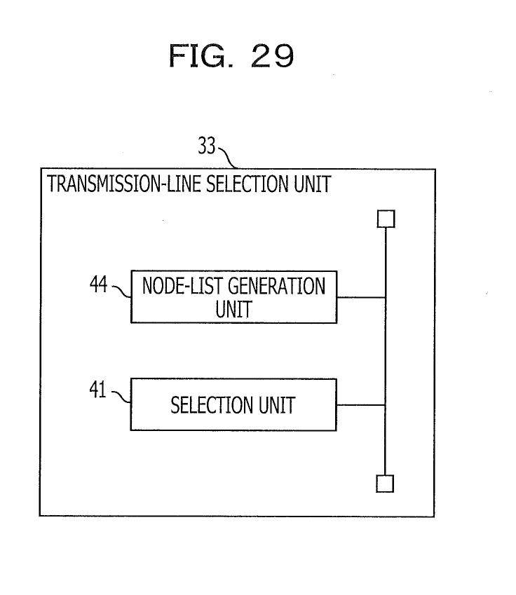

Next, a description will be given of a path search apparatus 1 according to another embodiment. FIG. 29 is a diagram illustrating an example of a third configuration of the transmission-line selection unit 33. The transmission-line selection unit 33 includes a selection unit 41 and a node-list generation unit 44. The node-list generation unit 44 generates a node list that includes individual nodes on the physical topology. The node list is a list of candidate adjacent nodes, on the end-point side, that the demand may go through next out of the nodes coupled to a target node through a link on the physical topology. For example, the node list may be a list of nodes, among the nodes coupled to the target node on the physical topology, that have a shorter shortest distance than that of the target node.

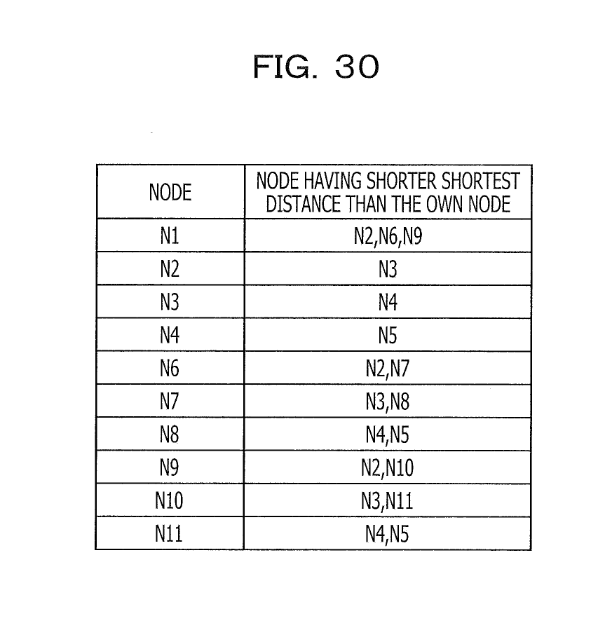

FIG. 30 is an explanatory diagram of an example of a node list. For example, for the node N2, the shortest distance of the node N2 is “3 km”, and the shortest distances of the adjacent nodes N1, N3, N6 and N9, which are coupled to the node N2, are “4 km”, “2 km”, “4.5 km” and “4.5 km”, respectively. Accordingly, the node list of the node N2 includes the node N3, which has a shorter shortest distance than the node N2.

The selection unit 41 refers to the node list generated for individual nodes on the transmission line for each transmission line, and determines whether or not a node next to the current node is included in the node list. Here, a “next node” is a node through which the transmission line passes next after the node of interest when going in the indicated direction. That is, the “next node” is a node adjacent to the current node on the end-point side. If a next node is included in the node list for all the nodes on the transmission line, the selection unit 41 selects the transmission line.

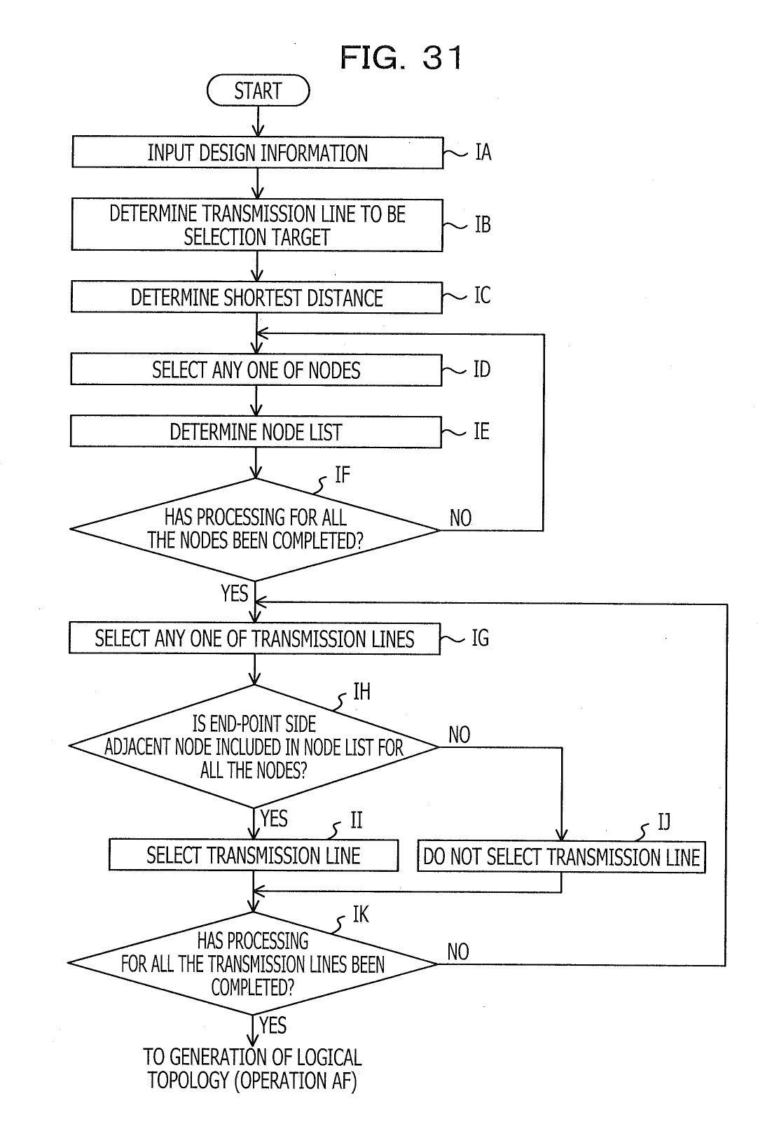

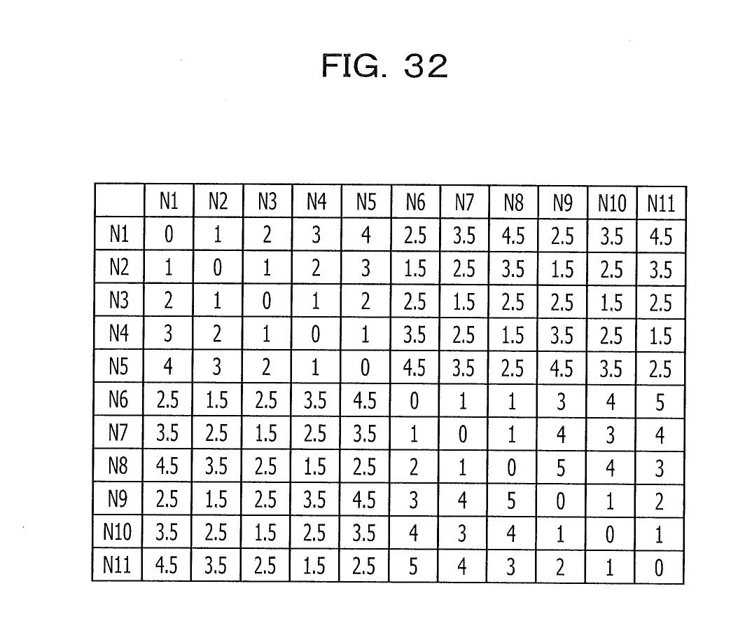

FIG. 31 is an explanatory diagram of the path search processing according to the present embodiment. In this regard, in other embodiments, the following operation IA to IK may be steps. The processing in operation IA to IC is the same as the processing in operation AA to AC illustrated in FIG. 19, and description thereof is omitted.

In operation ID, the node-list generation unit 44 selects a node for which a node list has not been generated for the nodes on the physical topology. In operation IE, the node-list generation unit 44 generates a node list for the selected node. In operation IF, the node-list generation unit 44 determines whether or not a node list has been generated for all the nodes. If a node list has been generated for all the nodes (operation IF: Y), the processing proceeds to operation IG. If there is a node for which a node list has not been generated (operation IF: N), the processing returns to operation ID.

In operation IG, the selection unit 41 selects a transmission lines for which selection processing has not yet been performed out of the transmission lines specified by the transmission line information. In operation IH, the selection unit 41 determines, for each node on the selected transmission line, whether or not a next node is included in a node list for the node. If a next node is included in the node list for each node in the selected transmission line (operation IH: Y), the processing proceeds to operation II. If a next node is not included in the node list for each node in the selected transmission line (operation IH: N), the processing proceeds to operation IJ.

In operation II, the selection unit 41 selects the transmission line. Afterwards, the processing proceeds to operation IK. In operation IJ, the selection unit 41 does not select the transmission line. Afterwards, the processing proceeds to operation IK. In operation IK, the transmission-line selection unit 33 determines whether or not selection processing has been performed for all the transmission lines. If the selection processing is performed for all the transmission lines (operation IK: Y), path search is carried out with the same processing as the processing in operation AF to AJ illustrated in FIG. 19. If there is a transmission line for which selection processing has not been performed yet (operation IK: N), the processing returns to operation IG.

In this regard, in the present embodiment, a node list is specified as a list of candidate adjacent nodes, on the end-point side, that the demand going through the individual nodes can go through next. In other embodiments, a list of candidates of adjacent nodes, on the end-point side, that a demand passing through individual nodes is unable to pass through next may be specified instead. In this case, if a next node is not included in the node list for any node on the transmission line, the selection unit 41 selects the transmission line.

According to the present embodiment, it may be possible to omit creation of the link direction information illustrated in FIG. 13, and thus it may be possible to reduce the amount of data used for path search with a network that includes a large number of links on the physical topology.

### 7. Seventh Embodiment

Next, a description will be given of a path search apparatus 1 according to another embodiment. In the above-described first to sixth embodiments, the minimum-cost determination unit 31 has determined shortest distances for individual nodes. In the present embodiment, shortest distances between nodes are obtained for each pair of nodes on the physical topology in advance, and are stored in the auxiliary storage unit 4 as a shortest distance table. FIG. 32 is an explanatory diagram of a shortest distance table.

For example, referring to the first row, the shortest distance between the node N1 and the individual nodes N2 to N11 are “1”, “2”, “3”, “4”, “2.5”, “3.5”, “4.5”, “2.5”, “3.5” and “4.5”, respectively. The transmission-line selection unit 33 refers to the shortest distance table, and obtains shortest distance information for each node to be used when selecting a transmission line that forms a logical topology on which path search is carried out.

The shortest distance table is input, for example, through a design-information accepting unit 30, and may be stored in the auxiliary storage unit 4. In this case, the path search apparatus 1 may omit the minimum-cost determination unit 31. Alternatively, when circuit capacity design is repeated, the minimum-cost determination unit 31 may determine the shortest distance table at least once.

According to the present embodiment, when circuit capacity design is repeated, it may be possible to omit repeating the calculation of a minimum cost. Accordingly, it may be possible to reduce time and processing used for circuit capacity design.

### 8. Eighth Embodiment

Next, a description will be given of a path search apparatus 1 according to another embodiment. In the present embodiment, prior to path search, whether it is possible or not to search for a path that accommodates a demand is determined. If it is not possible to search for a path, a path search is not carried out and the processing is terminated.

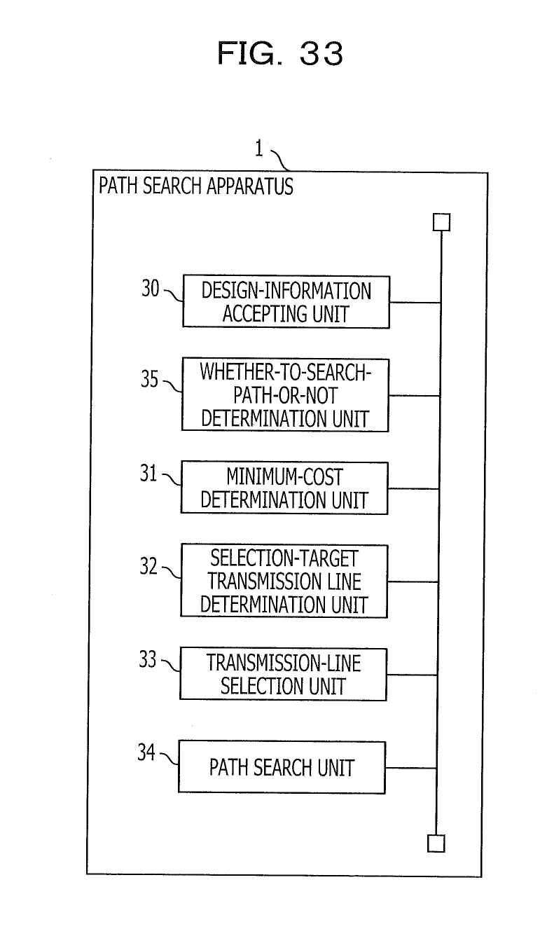

FIG. 33 is a diagram illustrating a configuration of the path search apparatus according to the present embodiment. The path search apparatus 1 includes a whether-to-search-path-or-not determination unit 35 that determines whether or not it is possible to search for a path to accommodate a demand, and determines whether or not to search for a path depending on a determination result. The whether-to-search-path-or-not determination unit 35 may, for example, determine that it is not possible to search for a path to accommodate a demand, if there is no transmission line that has either the start node or end node of the demand as end points.

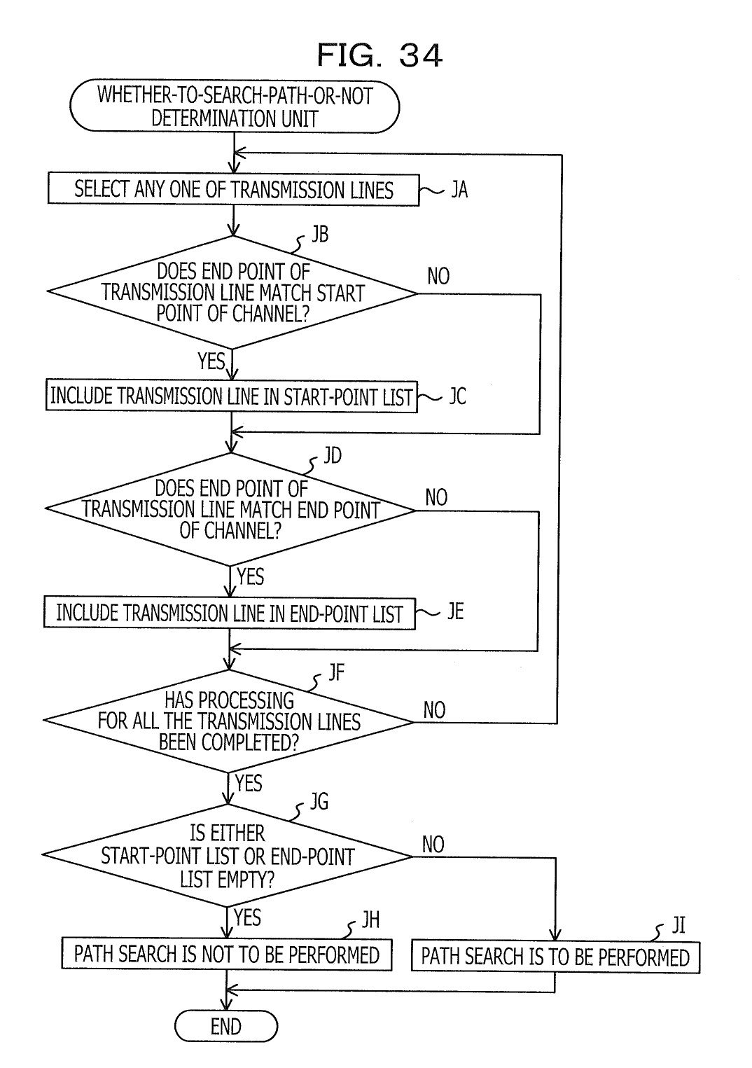

FIG. 34 is an explanatory diagram of determination processing of whether to search for a path or not performed by the whether-to-search-path-or-not determination unit 35. In this regard, in another embodiment, the following operations JA to JI may be steps. In operation JA, the whether-to-search-path-or-not determination unit 35 selects a transmission line specified by the transmission line information.

In operation JB, the whether-to-search-path-or-not determination unit 35 determines whether or not either end node of the selected transmission line matches the demand's start node. If either end node of the transmission line matches the start node of the demand (operation JB: Y), the processing proceeds to operation JC. If neither of the transmission line's end nodes matches the start node of the demand (operation JB: N), the processing proceeds to operation JD. In operation JC, whether-to-search-path-or-not determination unit 35 includes the transmission line in a start point list. The start point list is a list of transmission lines that have the start node of the demand as an end point.

In operation JD, the whether-to-search-path-or-not determination unit 35 determines whether or not either end node of the selected transmission line matches the end node of the demand. If either end node of the transmission line matches the demand's end node (operation JD: Y), the processing proceeds to operation JE. If neither end node matches the demand's end node (operation JD: N), the processing proceeds to operation JF. In operation JE, the whether-to-search-path-or-not determination unit 35 includes the transmission line in an end point list. The end point list is a list of transmission lines that have the end node of the demand as an end point.

In operation JF, the whether-to-search-path-or-not determination unit 35 determines whether or not the processing in operations JB to JE has been performed for all the transmission lines. If processing for all the transmission lines has been performed (operation JF: Y), the processing proceeds to operation JG. If there is a transmission line for which processing has not been performed (operation JF: N), the processing returns to operation JA.

In operation JG, the whether-to-search-path-or-not determination unit 35 determines whether or not the start point list and the end point list are empty. If at least one of the start point list and the end point list is empty (operation JG: Y), the processing proceeds to operation JH. If neither the start point list nor the end point list is empty (operation JG: N), the processing proceeds to operation JI.

In operation JH, the whether-to-search-path-or-not determination unit 35 determines that path search is not to be performed for the demand. Afterwards, the processing is terminated. In operation JI, the whether-to-search-path-or-not determination unit 35 determines that path search is to be performed for the demand. Afterwards, the processing is terminated.

According to the present embodiment, if there is no apparent path to accommodate a demand, it is possible to stop the search for a path. Accordingly, it may be possible to avoid performing wasteful processing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable recording medium having stored therein a program for causing a computer to execute a process comprising:
accepting a start node and finish node that are both terminuses for a circuit that is to be accommodated in a transmission network that includes a plurality of transmission lines;
selecting, from the plurality of transmission lines, a transmission line whose arrangement order of arranging a plurality of nodes on the transmission line in an order of an indicated direction determined for the transmission line is the same as an order of the plurality of nodes determined in accordance with a cost order of the shortest path from a node at a terminus of the circuit to the plurality of nodes; and
searching for a path from the circuit's start node to the circuit's finish node via the selected transmission line in the order of the indicated direction.

2. The computer-readable recording medium according to claim 1,
wherein on selecting a transmission line having an arrangement order, which involves arranging the plurality of nodes in order of the indicated direction, that is the same as an order of the plurality of nodes determined in accordance with the cost order, the process further comprises:
determining, in accordance with a cost order of the shortest path from the node at a terminus of the circuit to both end nodes of a link in the transmission network, the link's direction, and
comparing the link's direction in the transmission line with the indicated direction of the transmission line so as to determine whether an arrangement order of arranging both end nodes of the link in the order of the indicated direction is equal to an order of both end nodes of the link, which is determined in accordance with the cost order of the shortest path from the node at a terminus of the circuit to both end nodes of the link.

3. The computer-readable recording medium according to claim 2,
wherein when the cost of the shortest path from the node at a terminus of the circuit is the same for both end nodes of the link, a determination is made that the order of both end nodes of the link, which is determined in accordance with the cost order, is the same as the arrangement order of arranging both end nodes of the link in the order of the indicated direction.

4. The computer-readable recording medium according to claim 1,
wherein on selecting a transmission line whose arrangement order of arranging the plurality of nodes in order of the indicated direction is the same as the order of the plurality of nodes as determined in accordance with the cost order, the process further comprises:
comparing a shortest path cost from the node at a terminus of the circuit to a first node on the transmission line with a shortest path cost from the node at a terminus of the circuit to a second node adjacent to the first node so as to determine whether an arrangement order of arranging the first node and the second node in the order of the indicated direction is the same as an order of the first node and the second node determined in accordance with the cost order of the shortest path from the node at a terminus of the circuit.

5. The computer-readable recording medium according to claim 1,
wherein on selecting a transmission line whose arrangement order of arranging the plurality in order of the indicated direction is the same as the order of the plurality of nodes determined in accordance with the cost order, the process further comprises:
selecting, from nodes coupled by a link to a first node on the transmission line, a coupled node having a given magnitude relation between a cost of a shortest path from the node at a terminus of the circuit to the first node and a cost of a shortest path from the node at a terminus of the circuit to the coupled node, which is coupled to the first node by a link, and
determining whether a second node adjacent to the first node matches any one of the selected nodes so as to determine whether an arrangement order of arranging the first node and the second node in the order of the indicated direction is equal to order of the first node and the second node determined in accordance with the cost order of the shortest path from the node at a terminus of the circuit.

6. The computer-readable recording medium according to claim 1,
wherein on selecting a transmission line whose arrangement order of arranging the plurality of nodes in the order of the indicated direction is the same as the order of the plurality of nodes determined in accordance with cost order,
a cost of a shortest path from the node at a terminus of the circuit to the node at the other end of the circuit is set to a higher value than any node other than the nodes at both terminuses of the circuit.

7. The computer-readable recording medium according to claim 1,
wherein on selecting a transmission line whose arrangement order of arranging the plurality of nodes in order of the indicated direction is the same as the order of the plurality of nodes determined in accordance with the cost order,
only a transmission line having at least one of either a start point that is coupled to another transmission line or an end point that is coupled to another transmission line is determined to be a selection target.

8. A path search apparatus comprising:
a memory
to store a start node and a finish node that are both terminuses of a circuit that is to be accommodated in a transmission network that includes a plurality of transmission lines;
a processor
to select, from the plurality of transmission lines, a transmission line whose arrangement order of arranging a plurality of nodes on the transmission line in an order of an indicated direction determined for the transmission line is the same as an order of the plurality of nodes determined in accordance with a cost order of a shortest path from a node at a terminus of the circuit to the plurality of nodes, and
to search a path from the circuit's start node to the circuit's finish node via the selected transmission line in the order of the indicated direction.

9. The path search apparatus according to claim 8,
wherein the processor further to determine settings of a network apparatus on the transmission network.

10. The path search apparatus according to claim 8,
wherein the processor further to establish the circuit by controlling setting of a network apparatus on the transmission network in response to the input of the circuit's start node and the circuit's finish node.

11. A computer-implemented method of searching a path, the method comprising:
accepting input a start node and a finish node that are both ends of a circuit that is to be accommodated in a transmission network that includes a plurality of transmission lines;
selecting, by a processor, from the plurality of transmission lines, a transmission line whose arrangement order of arranging a plurality of nodes on the transmission line in an order of an indicated direction determined for the transmission line is the same as an order of the plurality of nodes determined in accordance with a cost order of a shortest path from a node at an end of the circuit to the plurality of nodes; and
searching, by a processor, a path from the circuit's start node to the circuit's finish node via the selected transmission line in the order of the indicated direction.
